(19) United States
(12) Patent Application Publication
(10) Pub. No.: US 2024/0205760 A1
(43) Pub. Date: Jun. 20, 2024

(54) METHOD AND APPARATUS FOR HANDLING HANDOVER PREPARATION IN A WIRELESS COMMUNICATION SYSTEM

(71) Applicant: ASUS Technology Licensing Inc., Taipei City (TW)

(72) Inventors: Yi-Hsuan Huang, Taipei City (TW); Meng-Hui Ou, Taipei City (TW)

(21) Appl. No.: 18/537,367

(22) Filed: Dec. 12, 2023

Related U.S. Application Data
(60) Provisional application No. 63/433,320, filed on Dec. 16, 2022.
(60) Provisional application No. 63/434,880, filed on Dec. 22, 2022.
(60) Provisional application No. 63/436,856, filed on Jan. 3, 2023.

(51) Int. Cl. H04W 36/00

(52) U.S. Cl. CPC H04W 36/0055

(57) ABSTRACT

Systems and apparatuses are provided for a method for a first network node in a wireless communication system comprising receiving a first configuration from a second network node, broadcasting the first configuration via a system information in a first cell, transmitting a handover request to the second network node, wherein the handover request indicates to skip the first configuration in a handover command, receiving, in response to transmitting the handover request, the handover command in a handover request acknowledge from the second network node, wherein the handover command includes a second configuration and does not include the first configuration, and transmitting the handover command to a User Equipment (UE).

### CROSS-REFERENCE TO RELATED APPLICATIONS

The present Application claims priority to and the benefit of U.S. Provisional Patent Application Ser. No. 63/433,320, filed Dec. 16, 2022, U.S. Provisional Patent Application Ser. No. 63/434,880, filed Dec. 22, 2022, and U.S. Provisional Patent Application Ser. No. 63/436,856, filed Jan. 3, 2023; with each of the referenced applications and disclosures fully incorporated herein by reference.

### FIELD

This disclosure generally relates to wireless communication networks and, more particularly, to a method and apparatus for handling handover preparation in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling handover preparation in a wireless communication system. In various embodiments, a network could perform common handover, group handover, and/or 2-step handover (for a group of User Equipment (UE)) in Non-Terrestrial Networks (NTNs). A target Next Generation Node B (gNB) could know what kinds of handover configuration should be provided to a source gNB, e.g., in case of group handover, common handover, and/or 2-step handover. The source gNB could handle the UE context information in HANDOVER REQUEST for common handover. The source gNB could request configuration for different types of handover. In various embodiments, signaling overhead for (group) handover can be further reduced, e.g., in NTN, for earth-moving cell.

Systems and apparatuses are provided for a method for a first network node in a wireless communication system comprising receiving a first configuration from a second network node, broadcasting the first configuration via a system information in a first cell, transmitting a handover request to the second network node, wherein the handover request indicates to skip the first configuration in a handover command, receiving, in response to transmitting the handover request, the handover command in a handover request acknowledge from the second network node, wherein the handover command includes a second configuration and does not include the first configuration, and transmitting the handover command to a User Equipment (UE).

Systems and apparatuses are provided for a method for a second network node in a wireless communication system comprising receiving a request from a first network node, wherein the request includes multiple or no UE context information, transmitting, in response to receiving the request, a response including a first configuration to the first network node, receiving a handover request from the first network node, wherein the handover request includes an indication for a common handover and/or a request of a second configuration, and/or in response to receiving the handover request: determining to not include the first configuration in a handover command, and transmitting the handover command including a second configuration without the first configuration in a handover request acknowledge to the first network node.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of Figure 16.14.1-1: Overall illustration of an NTN, from 3GPP TS 38.300 V17.2.0, “NR, NR and NG-RAN Overall Description, Stage 2.”

FIG. 6 is a reproduction of Figure 9.2.3.1-1: Inter-gNB handover procedures, from 3GPP TS 38.300 V17.2.0, “NR, NR and NG-RAN Overall Description, Stage 2.”

FIG. 7 if a reproduction of Figure 9.2.3.2.1-1: Intra-AMF/UPF Handover, from 3GPP TS 38.300 V17.2.0, “NR, NR and NG-RAN Overall Description, Stage 2.”

FIG. 8 is a reproduction of Figure 9.2.3.4.2-1: Intra-AMF/UPF Conditional Handover, from 3GPP TS 38.300 V17.2.0, “NR, NR and NG-RAN Overall Description, Stage 2.”

FIG. 9 is a reproduction of Figure 5.3.5.1-1: RRC reconfiguration, successful, from 3GPP TS 38.331 V17.2.0, “NR, RRC protocol specification.”

FIG. 10 is a reproduction of Figure 5.3.5.1-2: RRC reconfiguration, failure, from 3GPP TS 38.331 V17.2.0, “NR, RRC protocol specification.”

FIG. 11 is a reproduction of Figure 8.2.1.2-1: Handover Preparation, successful operation, from 3GPP TS 38.423 V17.2.0, “NG-RAN, Xn application protocol (XnAP).”

FIG. 12 is a reproduction of Figure 8.2.1.3-1: Handover Preparation, unsuccessful operation, from 3GPP TS 38.423 V17.2.0, “NG-RAN, Xn application protocol (XnAP).”

FIG. 13 is a reproduction of Figure 8.4.1.2: Xn Setup, successful operation, from 3GPP TS 38.423 V17.2.0, “NG-RAN, Xn application protocol (XnAP).”

FIG. 14 is a reproduction of Figure 8.4.2.2-1: NG-RAN node Configuration Update, successful operation, from 3GPP TS 38.423 V17.2.0, “NG-RAN, Xn application protocol (XnAP).”

FIG. 15 is a reproduction of Figure 8.4.1.2-1: Handover preparation: successful operation, from 3GPP TS 38.413 V17.2.0, “NG-RAN, NG Application Protocol (NGAP)”

FIG. 16 is a reproduction of Figure 8.4.2.2-1: Handover resource allocation: successful operation, from 3GPP TS 38.413 V17.2.0, “NG-RAN, NG Application Protocol (NGAP)”

FIG. 17 is a diagram of a source gNB transmitting a first handover command with UE-specific configuration to a first UE and transmitting a second handover command with UE-specific configuration to a second UE, in accordance with embodiments of the present invention.

FIG. 18 is a diagram where a source gNB may indicate the target gNB whether to provide the content of the second configuration (in the first configuration) by the handover request, and the source gNB may provide an indication in the handover request, in accordance with embodiments of the present invention.

FIG. 19 is a diagram where a target gNB may transmit the second configuration and/or a message comprising the second configuration if (or based on) various conditions are met, in accordance with embodiments of the present invention.

FIG. 20 is a diagram where a source gNB requests a common part of the handover configuration (e.g., a second configuration) without UE context information (or with multiple UE context information), in accordance with embodiments of the present invention.

FIG. 21 is a diagram where a source gNB provides an indication to the target gNB in a handover request to request a handover configuration (e.g., for common handover or legacy handover), in accordance with embodiments of the present invention.

FIG. 22 is a flow diagram of a method of a first network node comprising receiving a first configuration from a second network node, broadcasting the first configuration via a system information, transmitting a handover request to the second network node, receiving, in response to transmitting the handover request, a handover command, and transmitting the handover command to a UE, in accordance with embodiments of the present invention.

FIG. 23 is a flow diagram of a method of a second network node comprising receiving a request from a first network node, transmitting, in response to receiving the request, a response including a first configuration, receiving a handover request from the first network node, and/or in response to receiving the handover request: determining to not include a first configuration and transmitting the handover command including a second configuration, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-221819, “NR NTN (Non-Terrestrial Networks) enhancements.”; [2] 3GPP TR 38.821 V16.1.0, “Solutions for NR to support non-terrestrial networks (NTN).”; [3] 3GPP TS 38.300 V17.2.0, “NR, NR and NG-RAN Overall Description, Stage 2.”; [4] 3GPP TS 38.331 V17.2.0, “NR, RRC protocol specification.”; [5] 3GPP TS 38.423 V17.2.0, “NG-RAN, Xn application protocol (XnAP).”; [6] R2-2209711, “Signaling and congestion reduction in satellite switch.”; and [7] 3GPP TS 38.413 V17.2.0, “NG-RAN, NG Application Protocol (NGAP).” The standards and documents listed above are hereby expressly and fully incorporated herein by reference in their entirety.

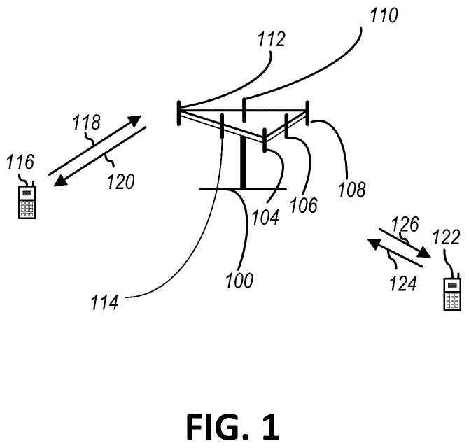

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

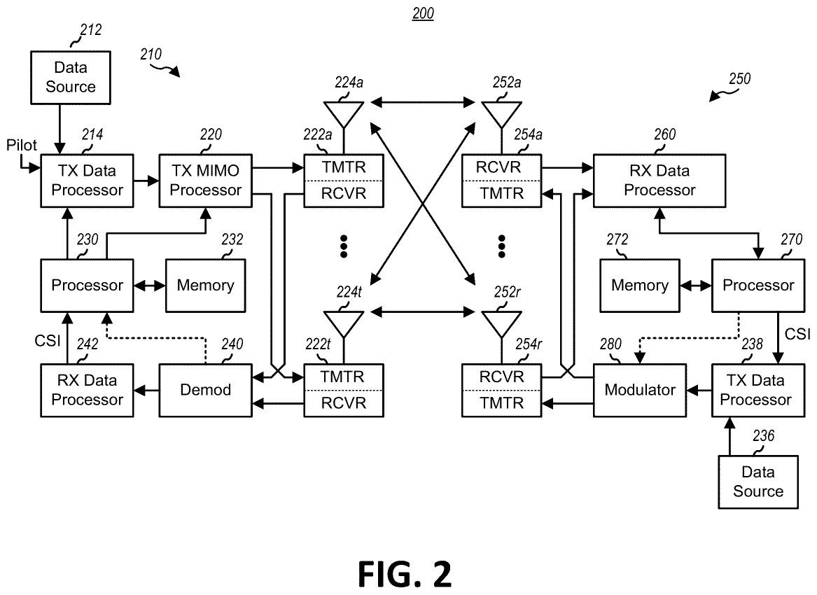

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

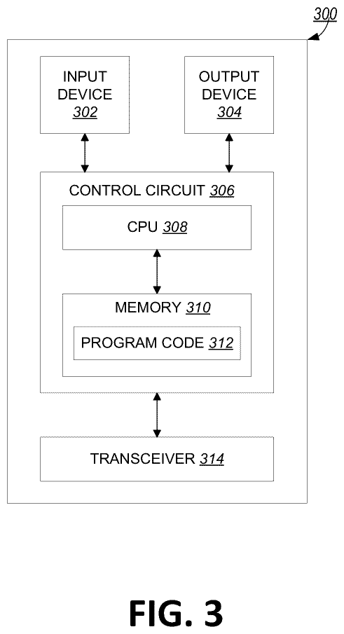

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

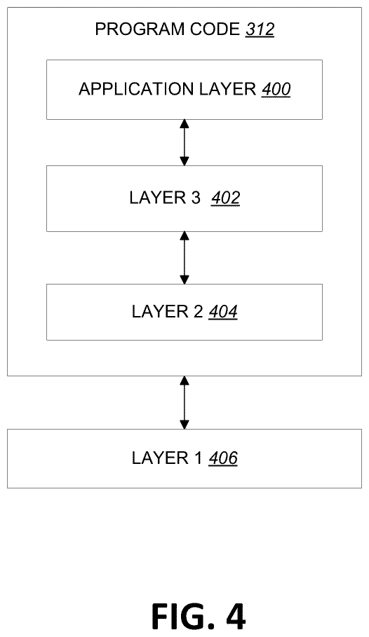

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention is disclosure is just one possible embodiment which would not restrict the specific method or apparatus.

The general description of Rel-17 NR non-terrestrial networks (NTN) is specified in TS 38.300 ([3]3GPP TS 38.300 V17.2.0, “NR, NR and NG-RAN Overall Description, Stage 2.”):

### Quotation Start [3]

### 16.14 Non-Terrestrial Networks

### 16.14.1 Overview

Figure 16.14.1-1 below illustrates an example of a Non-Terrestrial Network (NTN) providing non-terrestrial NR access to the UE by means of an NTN payload and an NTN Gateway, depicting a service link between the NTN payload and a UE, and a feeder link between the NTN Gateway and the NTN payload.

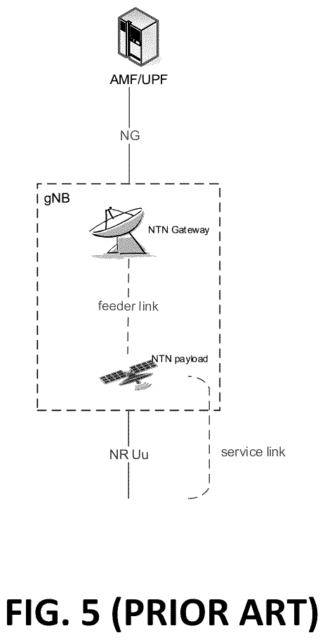

FIG. 5 is a reproduction of Figure 16.14.1-1: Overall illustration of an NTN, from 3GPP TS 38.300 V17.2.0, “NR, NR and NG-RAN Overall Description, Stage 2.”

The NTN payload transparently forwards the radio protocol received from the UE (via the service link) to the NTN Gateway (via the feeder link) and vice-versa. The following connectivity is supported by the NTN payload:
An NTN gateway may serve multiple NTN payloads;
An NTN payload may be served by multiple NTN gateway.

Three types of service links are supported:
Earth-fixed: provisioned by beam(s) continuously covering the same geographical areas all the time (e.g., the case of GSO satellites);
Quasi-Earth-fixed: provisioned by beam(s) covering one geographic area for a limited period and a different geographic area during another period (e.g., the case of NGSO satellites generating steerable beams);
Earth-moving: provisioned by beam(s) whose coverage area slides over the Earth surface (e.g., the case of NGSO satellites generating fixed or non-steerable beams).

With NGSO satellites, the gNB can provide either quasi-Earth-fixed service link or Earth-moving service link, while gNB operating with GSO satellite can provide Earth fixed service link.

In this release, the UE supporting NTN is GNSS-capable.

### 16.14.3.2 Mobility in RRC_CONNECTED

### 16.14.3.2.1 Handover

UE may support mobility between radio access technologies each based on different orbit (GSO, NGSO at different altitude).

### Quotation End

The work item of Rel-18 NR NTN is specified in [1] RP-221819, “NR NTN (Non-Terrestrial Networks) enhancements.”:

### Quotation Start [1]

In Release 17, a work item was carried out to define solutions enabling New Radio and NG-RAN to support Non-Terrestrial Networks (NTN):
Transparent payload based GSO and NGSO network scenarios addressing at least 3GPP power class 3 UE with GNSS capability in both Earth fixed and/or moving cell configurations

As part of Release 18, a new work item is proposed to define enhancements for NG-RAN based Non-Terrestrial Networks in order to:
Support new scenarios to cover deployments in frequency bands above 10 GHz
Offer optimized performance especially when addressing handset terminals (including smartphones with more realistic assumptions on antenna gains instead of 0 dBi antenna gain with the specific realistic antenna gain assumption to be determined at the working group level) w.r.t. coverage considering the NTN characteristics such as large propagation delay and satellite movement.
Provide mobility and service continuity enhancements considering the NTN characteristics such as large propagation delay and satellite movement.
Address requirements, if needed based on the FS_NR_NTN_netw_verif_UE_loc study outcome, which mandate the network operator to cross check the UE location reported by the UE, which needs to be carried out in order to fulfil the regulatory requirements (e.g., Lawful intercept, emergency call, Public Warning System, . . . ) regarding a network verified UE location i.e., to be able to check the UE reported location information (e.g. estimate UE location at the network side) and specify if needed mechanisms to fulfil the regulatory requirements.

### Quotation End

Some enhancements for NTN are described in TR 38.821 ([2] 3GPP TR 38.821 V16.1.0, “Solutions for NR to support non-terrestrial networks (NTN).”) as provided below:

### Quotation Start [2]

### 7.3.2.1.4 Frequent and Unavoidable Handover

Satellites in non-GEO orbits move with high speed relative to a fixed position on earth, leading to frequent and unavoidable handover for both stationary and moving UEs. This may result in significant signalling overhead and impact power consumption, as well as exacerbating other potential challenges related to mobility e.g. service interruption due to signalling latency.

For a UE travelling at a constant speed and direction, the maximum time it can remain connected to a cell is approximated by dividing the cell diameter by UE speed. For NTN LEO deployments, the cell size is divided by the relative speed between the satellite and the UE, where a UE moving in the same direction as the satellite subtracts from the relative speed, and a UE moving in the opposite direction increases relative speed, described by the equation below:

$$Time to HO ( s ) = \frac{cell size ( km )}{UE speed ( \frac{km}{h r} ) \cdot ( \frac{1 hr}{3600 s} ) + satellite speed ( \frac{km}{s} )}$$

The scenario of cell diameter=one 50 km diameter beam will represent the lower bound (i.e. worst-case scenario for HO frequency), and cell diameter=1000 km will be taken as the upper bound (i.e. best-case scenario for HO frequency).

Substituting reference values from 4.2-2 and 7.1-1 into the above equation, the maximum time a UE can remain in an NTN cell (i.e. the UE connects immediately at cell edge and leaves at the opposite cell edge) for the min/max cell diameter and relative speed is listed in the table below:

TABLE 7.3.2.1.4-1
Time to HO for min/max cell diameter and varying UE speed

| Cell Diameter | UE Speed | Satellite | Time to |
|---|---|---|---|
| Size (km) | (km/hr) | Speed (km/s) | HO (s) |
| 50 (lower | +500 | 7.56 (NOTE 1) | 6.49 |
| bound) | −500 | | 6.74 |
| | +1200 | | 6.33 |
| | −1200 | | 6.92 |
| | Neglected | | 6.61 |
| 1000 (upper | +500 | | 129.89 |
| bound) | −500 | | 134.75 |
| | +1200 | | 126.69 |
| | −1200 | | 138.38 |
| | Neglected | | 132.28 |

Neglecting UE movement, a UE served by an NTN LEO cell of diameter 50 km and 1000 km may remained connected for a maximum of 6.61 seconds and 132.38 seconds respectively due to satellite movement. Considering UE movement, this will vary by approximately +/−4%. By neglecting satellite speed and setting UE speed to 500 km/hr as per table 7.1-1, this is equivalent to a terrestrial UE being served by a cell diameter ranging from approximately 0.918 km (NOTE 2) to 18.39 km.

From the above analysis, it is concluded that HO frequency in LEO NTN can be similar to that experienced by a terrestrial UE on a high-speed train, however this represents a worst-case scenario and is not indicative of a typical terrestrial network. It is not anticipated that frequent HO will occur in GEO due to large cell size limiting the impact of UE speed. It is further assumed in LEO scenarios UE speed is a negligible factor in HO frequency given the relative speed of the satellite, and this will principally be an issue for LEO with moving beams.

### Quotation End

The general description of handover procedure is specified in TS 38.300 ([3] 3GPP TS 38.300 V17.2.0, “NR, NR and NG-RAN Overall Description, Stage 2.”) as provided below:

### Quotation Start [3]

### 9.2.3 Mobility in RRC_CONNECTED

### 9.2.3.1 Overview

Network controlled mobility applies to UEs in RRC_CONNECTED and is categorized into two types of mobility: cell level mobility and beam level mobility. Beam level mobility includes intra-cell beam level mobility and inter-cell beam level mobility.

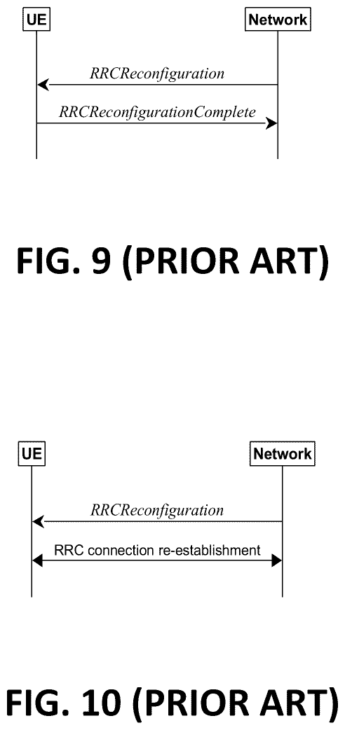

Cell Level Mobility requires explicit RRC signalling to be triggered, i.e. handover. For inter-gNB handover, the signalling procedures consist of at least the following elemental components illustrated in Figure 9.2.3.1-1:

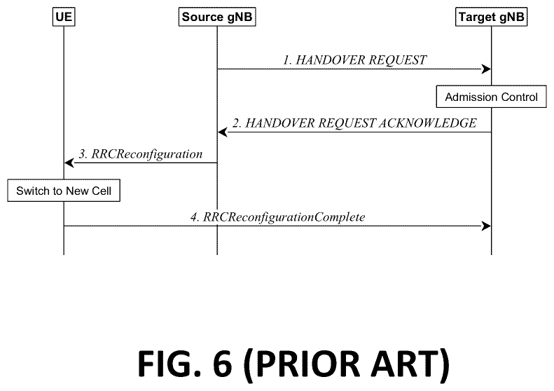

FIG. 6 is a reproduction of Figure 9.2.3.1-1: Inter-gNB handover procedures, from 3GPP TS 38.300 V17.2.0, “NR, NR and NG-RAN Overall Description, Stage 2.”
1. The source gNB initiates handover and issues a HANDOVER REQUEST over the Xn interface.
2. The target gNB performs admission control and provides the new RRC configuration as part of the HANDOVER REQUEST ACKNOWLEDGE.
3. The source gNB provides the RRC configuration to the UE by forwarding the RRCReconfiguration message received in the HANDOVER REQUEST ACKNOWLEDGE. The RRCReconfiguration message includes at least cell ID and all information required to access the target cell so that the UE can access the target cell without reading system information. For some cases, the information required for contention-based and contention-free random access can be included in the RRCReconfiguration message. The access information to the target cell may include beam specific information, if any.
4. The UE moves the RRC connection to the target gNB and replies with the RRCReconfigurationComplete.
NOTE 1: User Data can also be sent in step 4 if the grant allows.

### 9.2.3.2 Handover

### 9.2.3.2.1 C-Plane Handling

The intra-NR RAN handover performs the preparation and execution phase of the handover procedure performed without involvement of the 5GC, i.e. preparation messages are directly exchanged between the gNBs. The release of the resources at the source gNB during the handover completion phase is triggered by the target gNB. The figure below depicts the basic handover scenario where neither the AMF nor the UPF changes:

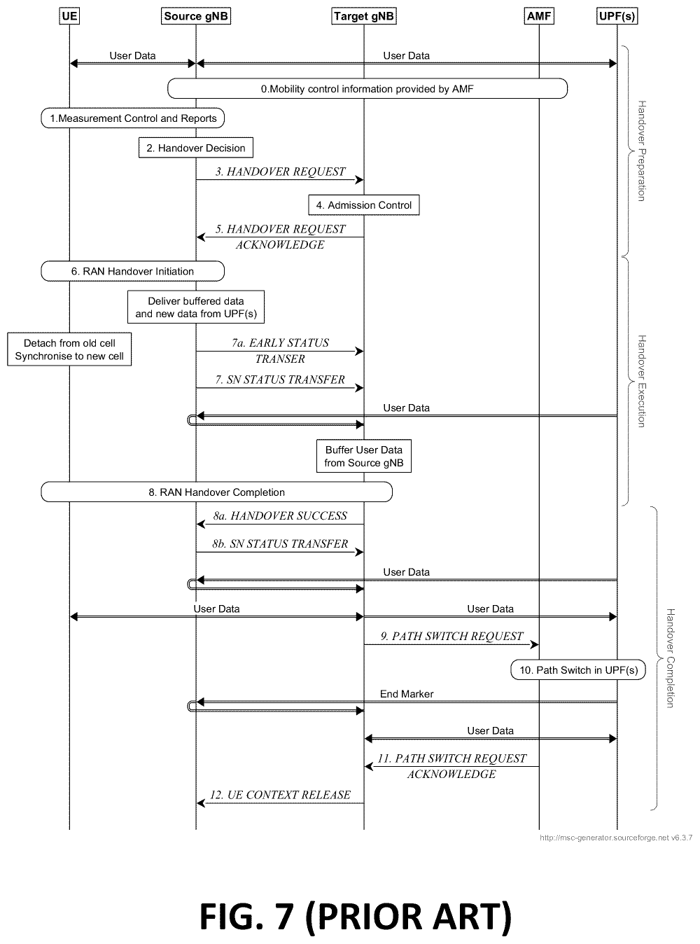

FIG. 7 if a reproduction of Figure 9.2.3.2.1-1: Intra-AMF/UPF Handover, from 3GPP TS 38.300 V17.2.0, “NR, NR and NG-RAN Overall Description, Stage 2.”
0. The UE context within the source gNB contains information regarding roaming and access restrictions which were provided either at connection establishment or at the last TA update.
1. The source gNB configures the UE measurement procedures and the UE reports according to the measurement configuration.
2. The source gNB decides to handover the UE, based on MeasurementReport and RRM information.
3. The source gNB issues a Handover Request message to the target gNB passing a transparent RRC container with necessary information to prepare the handover at the target side. The information includes at least the target cell ID, KgNB*, the C-RNTI of the UE in the source gNB, RRM-configuration including UE inactive time, basic AS-configuration including antenna Info and DL Carrier Frequency, the current QoS flow to DRB mapping rules applied to the UE, the SIB1 from source gNB, the UE capabilities for different RATs, PDU session related information, and can include the UE reported measurement information including beam-related information if available. The PDU session related information includes the slice information and QoS flow level QoS profile(s). The source gNB may also request a DAPS handover for one or more DRBs.
NOTE 1: After issuing a Handover Request, the source gNB should not reconfigure the UE, including performing Reflective QoS flow to DRB mapping.
4. Admission Control may be performed by the target gNB. Slice-aware admission control shall be performed if the slice information is sent to the target gNB. If the PDU sessions are associated with non-supported slices the target gNB shall reject such PDU Sessions.
5. The target gNB prepares the handover with L1/L2 and sends the HANDOVER REQUEST ACKNOWLEDGE to the source gNB, which includes a transparent container to be sent to the UE as an RRC message to perform the handover. The target gNB also indicates if a DAPS handover is accepted.
NOTE 2: As soon as the source gNB receives the HANDOVER REQUEST ACKNOWLEDGE, or as soon as the transmission of the handover command is initiated in the downlink, data forwarding may be initiated.
6. The source gNB triggers the Uu handover by sending an RRCReconfiguration message to the UE, containing the information required to access the target cell: at least the target cell ID, the new C-RNTI, the target gNB security algorithm identifiers for the selected security algorithms. It can also include a set of dedicated RACH resources, the association between RACH resources and SSB(s), the association between RACH resources and UE-specific CSI-RS configuration(s), common RACH resources, and system information of the target cell, etc.
7. For DRBs not configured with DAPS, the source gNB sends the SN STATUS TRANSFER message to the target gNB to convey the uplink PDCP SN receiver status and the downlink PDCP SN transmitter status of DRBs for which PDCP status preservation applies (i.e. for RLC AM). The uplink PDCP SN receiver status includes at least the PDCP SN of the first missing UL PDCP SDU and may include a bit map of the receive status of the out of sequence UL PDCP SDUs that the UE needs to retransmit in the target cell, if any. The downlink PDCP SN transmitter status indicates the next PDCP SN that the target gNB shall assign to new PDCP SDUs, not having a PDCP SN yet.
8. The UE synchronises to the target cell and completes the RRC handover procedure by sending RRCReconfigurationComplete message to target gNB. In case of DAPS handover, the UE does not detach from the source cell upon receiving the RRCReconfiguration message. The UE releases the source resources and configurations and stops DL/UL reception/transmission with the source upon receiving an explicit release from the target node.
9. The target gNB sends a PATH SWITCH REQUEST message to AMF to trigger 5GC to switch the DL data path towards the target gNB and to establish an NG-C interface instance towards the target gNB.
10. 5GC switches the DL data path towards the target gNB. The UPF sends one or more “end marker” packets on the old path to the source gNB per PDU session/tunnel and then can release any U-plane/TNL resources towards the source gNB.
11. The AMF confirms the PATH SWITCH REQUEST message with the PATH SWITCH REQUEST ACKNOWLEDGE message.
12. Upon reception of the PATH SWITCH REQUEST ACKNOWLEDGE message from the AMF, the target gNB sends the UE CONTEXT RELEASE to inform the source gNB about the success of the handover. The source gNB can then release radio and C-plane related resources associated to the UE context. Any ongoing data forwarding may continue.

The RRM configuration can include both beam measurement information (for layer 3 mobility) associated to SSB(s) and CSI-RS(s) for the reported cell(s) if both types of measurements are available. Also, if CA is configured, the RRM configuration can include the list of best cells on each frequency for which measurement information is available. And the RRM measurement information can also include the beam measurement for the listed cells that belong to the target gNB.

The common RACH configuration for beams in the target cell is only associated to the SSB(s). The network can have dedicated RACH configurations associated to the SSB(s) and/or have dedicated RACH configurations associated to CSI-RS(s) within a cell. The target gNB can only include one of the following RACH configurations in the Handover Command to enable the UE to access the target cell:
i) Common RACH configuration;
ii) Common RACH configuration+Dedicated RACH configuration associated with SSB;
iii) Common RACH configuration+Dedicated RACH configuration associated with CSI-RS.

The dedicated RACH configuration allocates RACH resource(s) together with a quality threshold to use them. When dedicated RACH resources are provided, they are prioritized by the UE and the UE shall not switch to contention-based RACH resources as long as the quality threshold of those dedicated resources is met. The order to access the dedicated RACH resources is up to UE implementation.

### 9.2.3.4 Conditional Handover

### 9.2.3.4.1 General

A Conditional Handover (CHO) is defined as a handover that is executed by the UE when one or more handover execution conditions are met. The UE starts evaluating the execution condition(s) upon receiving the CHO configuration, and stops evaluating the execution condition(s) once a handover is executed.

The following principles apply to CHO:
The CHO configuration contains the configuration of CHO candidate cell(s) generated by the candidate gNB(s) and execution condition(s) generated by the source gNB.
An execution condition may consist of one or two trigger condition(s) (CHO events A3/A5, as defined in [12]). Only single RS type is supported and at most two different trigger quantities (e.g. RSRP and RSRQ, RSRP and SINR, etc.) can be configured simultaneously for the evaluation of CHO execution condition of a single candidate cell.
Before any CHO execution condition is satisfied, upon reception of HO command (without CHO configuration), the UE executes the HO procedure as described in clause 9.2.3.2, regardless of any previously received CHO configuration.
While executing CHO, i.e. from the time when the UE starts synchronization with target cell, UE does not monitor source cell.

### 9.2.3.4.2 C-Plane Handling

As in intra-NR RAN handover, in intra-NR RAN CHO, the preparation and execution phase of the conditional handover procedure is performed without involvement of the 5GC; i.e. preparation messages are directly exchanged between gNBs. The release of the resources at the source gNB during the conditional handover completion phase is triggered by the target gNB. The figure below depicts the basic conditional handover scenario where neither the AMF nor the UPF changes:

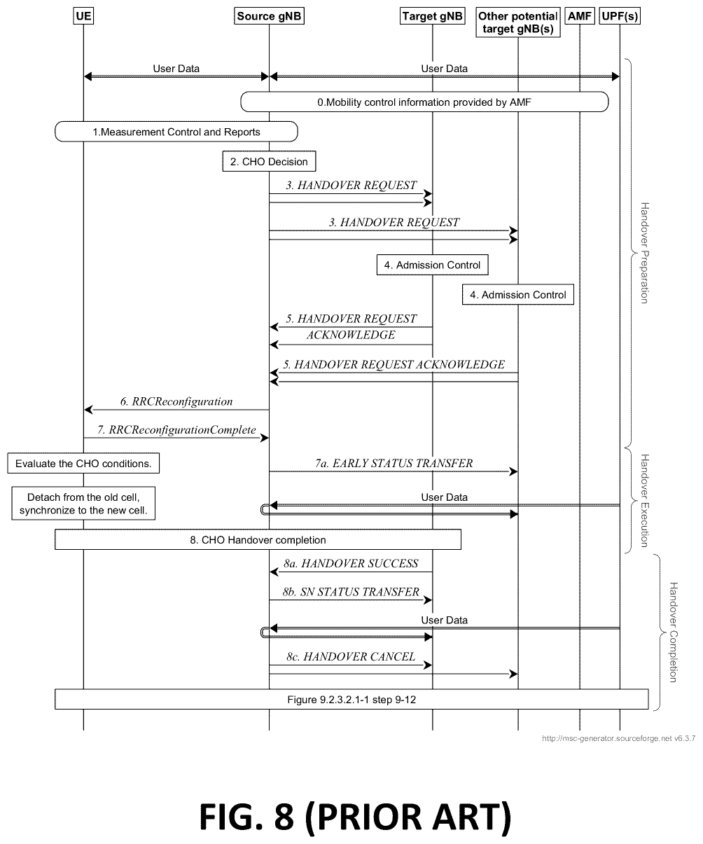

FIG. 8 is a reproduction of Figure 9.2.3.4.2-1: Intra-AMF/UPF Conditional Handover, from 3GPP TS 38.300 V17.2.0, “NR, NR and NG-RAN Overall Description, Stage 2.”
0/1. Same as step 0, 1 in Figure 9.2.3.2.1-1 of clause 9.2.3.2.1.
2. The source gNB decides to use CHO.
3. The source gNB requests CHO for one or more candidate cells belonging to one or more candidate gNBs. A CHO request message is sent for each candidate cell.
4. Same as step 4 in Figure 9.2.3.2.1-1 of clause 9.2.3.2.1.
5. The candidate gNB(s) sends CHO response (HO REQUEST ACKNOWLEDGE) including configuration of CHO candidate cell(s) to the source gNB. The CHO response message is sent for each candidate cell.
6. The source gNB sends an RRCReconfiguration message to the UE, containing the configuration of CHO candidate cell(s) and CHO execution condition(s).
NOTE 1: CHO configuration of candidate cells can be followed by other reconfiguration from the source gNB.
7. The UE sends an RRCReconfigurationComplete message to the source gNB.
7a If early data forwarding is applied, the source gNB sends the EARLY STATUS TRANSFER message.
8. The UE maintains connection with the source gNB after receiving CHO configuration, and starts evaluating the CHO execution conditions for the candidate cell(s). If at least one CHO candidate cell satisfies the corresponding CHO execution condition, the UE detaches from the source gNB, applies the stored corresponding configuration for that selected candidate cell, synchronises to that candidate cell and completes the RRC handover procedure by sending RRCReconfigurationComplete message to the target gNB. The UE releases stored CHO configurations after successful completion of RRC handover procedure.

### Quotation End

Some configurations related to handover are specified in TS 38.331 ([4] 3GPP TS 38.331 V17.2.0, “NR, RRC protocol specification.”) as provided below:

### Quotation Start [4]

### 5.3.5 RRC Reconfiguration

### 5.3.5.1 General

FIG. 9 is a reproduction of Figure 5.3.5.1-1: RRC reconfiguration, successful, from 3GPP TS 38.331 V17.2.0, “NR, RRC protocol specification.”

FIG. 10 is a reproduction of Figure 5.3.5.1-2: RRC reconfiguration, failure, from 3GPP TS 38.331 V17.2.0, “NR, RRC protocol specification.”

The purpose of this procedure is to modify an RRC connection, e.g. to establish/modify/release RBs/BH RLC channels/Uu Relay RLC channels/PC5 Relay RLC channels, to perform reconfiguration with sync, to setup/modify/release measurements, to add/modify/release SCells and cell groups, to add/modify/release conditional handover configuration, to add/modify/release conditional PSCell change or conditional PSCell addition configuration. As part of the procedure, NAS dedicated information may be transferred from the Network to the UE.

### Next Quotation

### RRCReconfiguration

The RRCReconfiguration message is the command to modify an RRC connection. It may convey information for measurement configuration, mobility control, radio resource configuration (including RBs, MAC main configuration and physical channel configuration) and AS security configuration.
Signalling radio bearer: SRB1 or SRB3
RLC-SAP: AM
Logical channel: DCCH
Direction: Network to UE

RRCReconfiguration message

[...]

| | |
|---|---|
| RRCReconfiguration-IEs ::= | SEQUENCE { |
| radioBearerConfig | RadioBearerConfig |

OPTIONAL, -- Need M
[...]

| | |
|---|---|
| measConfig | MeasConfig |

OPTIONAL, -- Need M
[...]
}

| | |
|---|---|
| RRCReconfiguration-v1530-IEs ::= | SEQUENCE { |
| masterCellGroup | OCTET STRING (CONTAINING CellGroupConfig) |

OPTIONAL, -- Need M

| | |
|---|---|
| fullConfig | ENUMERATED {true} |

OPTIONAL, -- Cond FullConfig

| | |
|---|---|
| dedicatedNAS-MessageList | SEQUENCE (SIZE(1..maxDRB)) OF DedicatedNAS-Message |

OPTIONAL, -- Cond nonHO

| | |
|---|---|
| masterKeyUpdate | MasterKeyUpdate |

OPTIONAL, -- Cond MasterKeyChange

| | |
|---|---|
| dedicatedSIB1-Delivery | OCTET STRING (CONTAINING SIB1) |

OPTIONAL, -- Need N

| | |
|---|---|
| dedicatedSystemInformationDelivery | OCTET STRING (CONTAINING SystemInformation) |

OPTIONAL, -- Need N

| | |
|---|---|
| otherConfig | OtherConfig |

OPTIONAL, -- Need M
[...]
}
[...]

| | |
|---|---|
| RRCReconfiguration-v1610-IEs ::= | SEQUENCE { |

[...]

| | |
|---|---|
| conditionalReconfiguration-r16 | ConditionalReconfiguration-r16 |

OPTIONAL, -- Need M
[...]

| | |
|---|---|
| onDemandSIB-Request-r16 | SetupRelease { OnDemandSIB-Request-r16 } |

OPTIONAL, -- Need M

| | |
|---|---|
| dedicatedPosSysInfoDelivery-r16 | OCTET STRING (CONTAINING PosSystemInformation-r16-IEs) |

OPTIONAL, -- Need N
[...]
}
[...]

RRCReconfiguration-IEs field descriptions

conditionalReconfiguration
Configuration of candidate target SpCell(s) and execution condition(s) for conditional handover, conditional PSCell
addition or conditional PSCell change. The field is absent if any DAPS bearer is configured or if the masterCellGroup
includes ReconfigurationWithSync or if the sl-L2RemoteUE-Config or sl-L2RelayUE-Config is configured. For conditional
PSCell change, the field is absent if the secondaryCellGroup includes ReconfigurationWithSync. The
RRCReconfiguration message contained in DLInformationTransferMRDC cannot contain the field
conditionalReconfiguration for conditional PSCell change or for conditional PSCell addition.
masterCellGroup
Configuration of master cell group.
otherConfig
Contains configuration related to other configurations. When configured for the SCG, only fields drx-PreferenceConfig,
maxBW-PreferenceConfig, maxBW-PreferenceConfigFR2-2, maxCC-PreferenceConfig, maxMIMO-
LayerPreferenceConfig, maxMIMO-LayerPreferenceConfigFR2-2, minSchedulingOffsetPreferenceConfig,
minSchedulingOffsetPreferenceConfigExt, btNameList, wlanNameList, sensorNameList and obtainCommonLocation can
be included.
radioBearerConfig
Configuration of Radio Bearers (DRBs, SRBs, multicast MRBs) including SDAP/PDCP. In EN-DC this field may only be
present if the RRCReconfiguration is transmitted over SRB3.

### CellGroupConfig

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells).

CellGroupConfig information element

-- Configuration of one Cell-Group:

| | |
|---|---|
| CellGroupConfig ::= | SEQUENCE { |
| cellGroupId | CellGroupId, |
| rlc-BearerToAddModList | SEQUENCE (SIZE(1..maxLC-ID)) OF RLC-BearerConfig |

OPTIONAL, -- Need N

| | |
|---|---|
| rlc-BearerToReleaseList | SEQUENCE (SIZE(1..maxLC-ID)) OF LogicalChannelIdentity |

OPTIONAL, -- Need N

| | |
|---|---|
| mac-CellGroupConfig | MAC-CellGroupConfig |

OPTIONAL, -- Need M

| | |
|---|---|
| physicalCellGroupConfig | PhysicalCellGroupConfig |

OPTIONAL, -- Need M

| | |
|---|---|
| spCellConfig | SpCellConfig |

OPTIONAL, -- Need M
[...]
}
-- Serving cell specific MAC and PHY parameters for a SpCell:

| | |
|---|---|
| SpCellConfig ::= | SEQUENCE { |
| servCellIndex | ServCellIndex |

OPTIONAL, -- Cond SCG

| | |
|---|---|
| reconfigurationWithSync | ReconfigurationWithSync |

OPTIONAL, -- Cond ReconfWithSync

| | |
|---|---|
| rlf-TimersAndConstants | SetupRelease { RLF-TimersAndConstants } |

OPTIONAL, -- Need M

| | |
|---|---|
| rlmInSyncOutOfSyncThreshold | ENUMERATED {n1} |

OPTIONAL, -- Need S

| | |
|---|---|
| spCellConfigDedicated | ServingCellConfig |

OPTIONAL, -- Need M

| | |
|---|---|
| ..., | |
| lowMobilityEvaluationConnected-r17 | SEQUENCE { |
| s-SearchDeltaP-Connected-r17 | ENUMERATED {dB3, dB6, dB9, dB12, dB15, spare3, spare2, |

spare1},

| | |
|---|---|
| t-SearchDeltaP-Connected-r17 | ENUMERATED {s5, s10, s20, s30, s60, s120, s180, s240, |

s300, spare7, spare6, spare5,

spare4, spare3, spare2, spare1}

}
OPTIONAL, -- Need R

| | |
|---|---|
| goodServingCellEvaluationRLM-r17 | GoodServingCellEvaluation-r17 |

OPTIONAL, -- Need R

| | |
|---|---|
| goodServingCellEvaluationBFD-r17 | GoodServingCellEvaluation-r17 |

OPTIONAL, -- Need R

| | |
|---|---|
| deactivatedSCG-Config-r17 | SetupRelease { DeactivatedSCG-Config-r17 } |

OPTIONAL -- Cond SCG-Opt
}

| | |
|---|---|
| ReconfigurationWithSync ::= | SEQUENCE { |
| spCellConfigCommon | ServingCellConfigCommon |

OPTIONAL,-- Need M

| | |
|---|---|
| newUE-Identity | RNTI-Value, |
| t304 | ENUMERATED {ms50, ms100, ms150, ms200, ms500, ms1000, ms2000, |

ms10000},

| | |
|---|---|
| rach-ConfigDedicated | CHOICE { |
| uplink | RACH-ConfigDedicated, |
| supplementaryUplink | RACH-ConfigDedicated |

```
  }
OPTIONAL, -- Need N
  ...,
  [[
```

| | |
|---|---|
| smtc | SSB-MTC |

```
OPTIONAL -- Need S
  ]],
  [[
```

| | |
|---|---|
| daps-UplinkPowerConfig-r16 | DAPS-UplinkPowerConfig-r16 |

OPTIONAL -- Need N
]],

| | |
|---|---|
| sl-PathSwitchConfig-r17 | SL-PathSwitchConfig-r17 |

OPTIONAL -- Cond DirectToIndirect-PathSwitch
}
[...]

CellGroupConfig field descriptions

mac-CellGroupConfig
MAC parameters applicable for the entire cell group.
rlmInSyncOutOfSyncThreshold
BLER threshold pair index for IS/OOS indication generation, see TS 38.133 [14], table 8.1.1-1. n1 corresponds to the
value 1. When the field is absent, the UE applies the value 0. Whenever this is reconfigured, UE resets N310 and N311,
and stops T310, if running. Network does not include this field.
spCellConfig
Parameters for the SpCell of this cell group (PCell of MCG or PSCell of SCG).

ReconfigurationWithSync field descriptions

rach-ConfigDedicated
Random access configuration to be used for the reconfiguration with sync (e.g. handover). The UE performs the RA
according to these parameters in the firstActiveUplinkBWP (see UplinkConfig).
smtc
The SSB periodicity/offset/duration configuration of target cell for NR PSCell change and NR PCell change. The network
sets the periodicityAndOffset to indicate the same periodicity as ssb-periodicityServingCell in spCellConfigCommon or
sets to the same periodicity as ssb-Periodicity-r17 in nonCellDefiningSSB-r17 if the first active DL BWP included in this
RRC message is configured with nonCellDefiningSSB-r17 for RedCap.
For case of NR PCell change, the smtc is based on the timing reference of (source) PCell. For case of NR PSCell
change, it is based on the timing reference of source PSCell.
If both this field and targetCellSMTC-SCG are absent, the UE uses the SMTC in the measObjectNR having the same
SSB frequency and subcarrier spacing, as configured before the reception of the RRC message. For a RedCap UE, if the
first active DL BWP included in this RRC message is configured with nonCellDefiningSSB-r17, this field corresponds to
the NCD-SSB indicated by nonCellDefiningSSB-r17, otherwise, this field corresponds to the CD-SSB indicated by
absoluteFrequencySSB in frequencyInfoDL.

SpCellConfig field descriptions

goodServingCellEvaluationBFD
Indicates the criterion for a UE to detect the good serving cell quality for BFD relaxation in the SpCell in
RRC_CONNECTED. The field is always configured when the network enables BFD relaxation for the UE in this SpCell.
goodServingCellEvaluationRLM
Indicates the criterion for a UE to detect the good serving cell quality for RLM relaxation in the SpCell in
RRC_CONNECTED. The field is always configured when the network enables RLM relaxation for the UE in this SpCell.
lowMobilityEvaluationConnected
Indicates the criterion for a UE to detect low mobility in RRC_CONNECTED in an SpCell. The s-SearchDeltaP-
Connected is the parameter “S_{SearchDeltaP-connected}”. Value dB 3 corresponds to 3 dB, dB 6 corresponds to 6 dB and so on.
The t-SearchDeltaP-Connected is the parameter “T_{SearchDeltaP-Connected}”. Value s 5 means 5 seconds, value s 10 means 10
seconds and so on. Low mobility criterion is configured in NR PCell for the case of NR SA/NR CA/NE-DC/NR-DC, and
in the NR PSCell for the case of EN-DC.
reconfigurationWithSync
Parameters for the synchronous reconfiguration to the target SpCell.
rlf-TimersAndConstants
Timers and constants for detecting and triggering cell-level radio link failure. For the SCG, rlf-TimersAndConstants can
only be set to setup and is always included at SCG addition.
servCellIndex
Serving cell ID of a PSCell. The PCell of the Master Cell Group uses ID = 0.

### NTN-Config

The IE NTN-Config provides parameters needed for the UE to access NR via NTN access.

NTN-Config information element

| | |
|---|---|
| NTN-Config-r17 ::= | SEQUENCE { |
| epochTime-r17 | EpochTime-r17 |

OPTIONAL, -- Need R
ntn-UlSyncValidityDuration-r17 ENUMERATED { s5, s10, s15, s20, s25, s30, s35,

s40, s45, s50, s55, s60, s120, s180, s240, s900}

OPTIONAL, -- Cond SIB19

| | |
|---|---|
| cellSpecificKoffset-r17 | INTEGER (1..1023) |

OPTIONAL, -- Need R

| | |
|---|---|
| kmac-r17 | INTEGER (1..512) |

OPTIONAL, -- Need R

| | |
|---|---|
| ta-Info-r17 | TA-Info-r17 |

OPTIONAL, -- Need R

| | |
|---|---|
| ntn-PolarizationDL-r17 | ENUMERATED {rhcp, lhcp, linear} |

OPTIONAL, -- Need R

| | |
|---|---|
| ntn-PolarizationUL-r17 | ENUMERATED {rhcp, lhcp, linear} |

OPTIONAL, -- Need R

| | |
|---|---|
| ephemerisInfo-r17 | EphemerisInfo-r17 |

OPTIONAL, -- Need R

| | |
|---|---|
| ta-Report-r17 | ENUMERATED {enabled} |

OPTIONAL, -- Need R
...
}

| | |
|---|---|
| EpochTime-r17 ::= | SEQUENCE { |
| sfn-r17 | INTEGER (0..1023), |
| subFrameNR-r17 | INTEGER (0..9) |

}

| | |
|---|---|
| TA-Info-r17 ::= | SEQUENCE { |
| ta-Common-r17 | INTEGER(0..66485757) , |
| ta-CommonDrift-r17 | INTEGER(−257303..257303) |

OPTIONAL, --Need R

| | |
|---|---|
| ta-CommonDriftVariant-r17 | INTEGER(0..28949) |

OPTIONAL -- Need R
}

NTN-Config field descriptions

EphemerisInfo
This field provides satellite ephemeris either in format of position and velocity state vector or in format of orbital
parameters. This field is excluded when determining changes in system information, i.e. changes to ephemeris Info
should neither result in system information change notifications nor in a modification of value Tag in SIB1.
epochTime
Indicate the epoch time for the NTN assistance information. When explicitly provided through SIB, or through dedicated
signaling, EpochTime is the starting time of a DL sub-frame, indicated by a SFN and a sub-frame number signaled
together with the assistance information. The reference point for epoch time of the serving satellite ephemeris and
Common TA parameters is the uplink time synchronization reference point. If this field is absent, the epoch time is the
end of SI window where this SIB19 is scheduled. This field is mandatory present when provided in dedicated
configuration. If this field is absent in ntn-Config provided via NTN-NeighCellConfig the UE uses epoch time from the
serving satellite ephemeris, otherwise the field is based on the timing of the serving cell, i.e. the SFN and sub-frame
number indicated in this field refers to the SFN and sub-frame of the serving cell. In case of handover, this field is based
on the timing of the target cell, i.e. the SFN and sub-frame number indicated in this field refers to the SFN and sub-frame
of the target cell. This field is excluded when determining changes in system information, i.e. changes to epochTime
should neither result in system information change notifications nor in a modification of valueTag in SIB1.
cellSpecificKoffset
Scheduling offset used for the timing relationships that are modified for NTN [see TS 38.211]. The unit of the field
K_offset is number of slots for a given subcarrier spacing of 15 kHz. If the field is absent UE assumes value 0.
kmac
Scheduling offset provided by network if downlink and uplink frame timing are not aligned at gNB. It is needed for UE
action and assumption on downlink configuration indicated by a MAC CE command in PDSCH [see TS 38.2xy]. If the
field is absent UE assumes value 0.
For the reference subcarrier spacing value for the unit of K_mac in FR1, a value of 15 kHz is used. The unit of K_mac is
number of slots for a given subcarrier spacing.
ntn-PolarizationDL
If present, this parameter indicates polarization information for downlink transmission on service link: including Right
hand, Left hand circular polarizations (RHCP, LHCP) and Linear polarization.
ntn-PolarizationUL
If present, this parameter indicates Polarization information for Uplink service link.
If not present and ntn-PolarizationDL is present, UE assumes the same polarization for UL and DL.
ntn-UISyncValidityDuration
A validity duration configured by the network for assistance information (i.e. Serving and/or neighbour satellite ephemeris
and Common TA parameters) which indicates the maximum time during which the UE can apply assistance information
without having acquired new assistance information.
The unit of ntn-UISync ValidityDuration is second. Value s 5 corresponds to 5 s, value s 10 indicate 10 s and so on. This
parameter applies to both connected and idle mode UEs. If this field is absent in ntn-Config provided via NTN-
NeighCellConfig, the UE uses validity duration from the serving cell assistance information. This field is excluded when
determining changes in system information, i.e. changes of ntn-UISyncValidityDuration should neither result in system
information change notifications nor in a modification of valueTag in SIB1. ntn-UISyncValidityDuration is only updated
when at least one of epochTime, ta-Info, ephemerisInfo is updated.
ta-Common
Network-controlled common timing advanced value and it may include any timing offset considered necessary by the
network. ta-Common with value of 0 is supported. The granularity of ta-Common is 4.072 × 10\hat{ }(−3) μs. Values are given
in unit of corresponding granularity. This field is excluded when determining changes in system information, i.e. changes
of ta-Common should neither result in system information change notifications nor in a modification of valueTag in SIB1.
ta-CommonDrift
Indicate drift rate of the common TA. The granularity of ta-CommonDrift is 0.2 × 10\hat{ }(−3) μs/s Values are given in unit
of corresponding granularity. This field is excluded when determining changes in system information, i.e. changes of ta-
CommonDrift should neither result in system information change notifications nor in a modification of valueTag in SIB1.
ta-CommonDriftVariant
Indicate drift rate variation of the common TA. The granularity of ta-CommonDriftVariation is 0.2 × 10\hat{ }(−4) μs/s\hat{ }2. Values
are given in unit of corresponding granularity. This field is excluded when determining changes in system information, i.e.
changes of ta-CommonDriftVariant should neither result in system information change notifications nor in a modification
of value Tag in SIB1.
ta-Report
When this field is included in SIB19, it indicates reporting of timing advanced is enabled during Random Access due to
RRC connection establishment or RRC connection resume, and during RRC connection reestablishment.. When this
field is included in ServingCellConfigCommon within dedicated signalling, it indicates TA reporting is enabled during
Random Access due to reconfiguration with sync (see TS 38.321 [3], clause 5.4.8).

| Conditional Presence | Explanation |
|---|---|
| SIB19 | The field is mandatory present for the |
| | serving cell in SIB19. The field is optionally |
| | present, Need R, otherwise. |

### ServingCellConfig

The IE Serving CellConfig is used to configure (add or modify) the UE with a serving cell, which may be the SpCell or an SCell of an MCG or SCG. The parameters herein are mostly UE specific but partly also cell specific (e.g. in additionally configured bandwidth parts). Reconfiguration between a PUCCH and PUCCH less SCell is only supported using an SCell release and add.

ServingCellConfig information element

| | |
|---|---|
| ServingCellConfig ::= | SEQUENCE { |
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF BWP-Id |

OPTIONAL, -- Need N

| | |
|---|---|
| downlinkBWP-ToAddModList | SEQUENCE (SIZE (1..maxNrofBWPs)) OF BWP-Downlink |

OPTIONAL, -- Need N

| | |
|---|---|
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, ms4, ms5, ms6, ms8, ms10, ms20, ms30, |
| | ms40, ms50, ms60, ms80, ms100, ms200, ms300, ms500, |
| | ms750, ms1280, ms1920, ms2560, spare10, spare9, |

spare8,

spare7, spare6, spare5, spare4, spare3, spare2,

spare1 } OPTIONAL, -- Need R

| | |
|---|---|
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M

| | |
|---|---|
| pdcch-ServingCellConfig | SetupRelease { PDCCH-ServingCellConfig } |

OPTIONAL, -- Need M

| | |
|---|---|
| pdsch-ServingCellConfig | SetupRelease { PDSCH-ServingCellConfig } |

OPTIONAL, -- Need M

| | |
|---|---|
| csi-MeasConfig | SetupRelease { CSI-MeasConfig } |

OPTIONAL, -- Need M

| | |
|---|---|
| sCellDeactivationTimer | ENUMERATED {ms20, ms40, ms80, ms160, ms200, ms240, |
| | ms320, ms400, ms480, ms520, ms640, ms720, |
| | ms840, ms1280, spare2, spare1} OPTIONAL, - |

- Cond ServingCellwithoutPUCCH

| | |
|---|---|
| crossCarrierSchedulingConfig | CrossCarrierSchedulingConfig |

OPTIONAL, -- Need M

| | |
|---|---|
| tag-Id | TAG-Id, |

[...]

| | |
|---|---|
| servingCellMO | MeasObjectId |

OPTIONAL, -- Cond MeasObject
[...]
}

| | |
|---|---|
| UplinkConfig ::= | SEQUENCE { |
| initialUplinkBWP | BWP-UplinkDedicated |

OPTIONAL, -- Need M

| | |
|---|---|
| uplinkBWP-ToReleaseList | SEQUENCE (SIZE (1..maxNrofBWPs)) OF BWP-Id |

OPTIONAL, -- Need N

| | |
|---|---|
| uplinkBWP-ToAddModList | SEQUENCE (SIZE (1..maxNrofBWPs)) OF BWP-Uplink |

OPTIONAL, -- Need N

| | |
|---|---|
| firstActiveUplinkBWP-Id | BWP-Id |

OPTIONAL, -- Cond SyncAndCellAdd

| | |
|---|---|
| pusch-ServingCellConfig | SetupRelease { PUSCH-ServingCellConfig } |

OPTIONAL, -- Need M

| | |
|---|---|
| carrierSwitching | SetupRelease { SRS-CarrierSwitching } |

OPTIONAL, -- Need M
[...]
}
[...]

ServingCellConfig field descriptions

bwp-InactivityTimer
The duration in ms after which the UE falls back to the default Bandwidth Part (see TS 38.321 [3], clause 5.15). When
the network releases the timer configuration, the UE stops the timer without switching to the default BWP.
defaultDownlinkBWP-Id
The initial bandwidth part is referred to by BWP-Id = 0. ID of the downlink bandwidth part to be used upon expiry of the
BWP inactivity timer. This field is UE specific. When the field is absent the UE uses the initial BWP as default BWP. (see
TS 38.213 [13], clause 12 and TS 38.321 [3], clause 5.15).
dormantBWP-Config
The dormant BWP configuration for an SCell. This field can be configured only for a (non-PUCCH) SCell.
firstActiveDownlinkBWP-Id
If configured for an SpCell, this field contains the ID of the DL BWP to be activated or to be used for RLM, BFD and
measurements if included in an RRCReconfiguration message contained in an NR or E-UTRA RRC message indicating
that the SCG is deactivated, upon performing the RRC (re-)configuration. If the field is absent, the RRC (re-)configuration
does not impose a BWP switch. If the field is absent for the PSCell at SCG deactivation, the UE considers the previously
activated DL BWP as the BWP to be used for RLM, BFD and measurements. If the field is absent for the PSCell at SCG
activation, the DL BWP to be activated is the DL BWP previously to be used for RLM, BFD and measurements.
If configured for an SCell, this field contains the ID of the downlink bandwidth part to be used upon activation of an SCell.
The initial bandwidth part is referred to by BWP-Id = 0.
Upon reconfiguration with reconfigurationWithSync, the network sets the firstActiveDownlinkBWP-Id and
firstActiveUplinkBWP-Id to the same value.
initialDownlinkBWP
The dedicated (UE-specific) configuration for the initial downlink bandwidth-part (i.e., DL BWP#0). If any of the optional
IEs are configured within this IE, the UE considers the BWP#0 to be an RRC configured BWP (from UE capability
viewpoint). Otherwise, the UE does not consider the BWP#0 as an RRC configured BWP (from UE capability viewpoint).
Network always configures the UE with a value for this field if no other BWPs are configured. NOTE1
pdsch-ServingCellConfig
PDSCH related parameters that are not BWP-specific.
supplementaryUplink
Network may configure this field only when supplementaryUplinkConfig is configured in ServingCellConfigCommon or
supplementaryUplink is configured in ServingCellConfigCommonSIB.
tag-Id
Timing Advance Group ID, as specified in TS 38.321 [3], which this cell belongs to.
uplinkConfig
Network may configure this field only when uplinkConfigCommon is configured in ServingCellConfigCommon or
ServingCellConfigCommonSIB. Addition or release of this field can only be done upon SCell addition or release
(respectively).

### ServingCellConfigCommon

The IE ServingCellConfigCommon is used to configure cell specific parameters of a UE's serving cell. The IE contains parameters which a UE would typically acquire from SSB, MIB or SIBs when accessing the cell from IDLE. With this IE, the network provides this information in dedicated signalling when configuring a UE with a SCells or with an additional cell group (SCG). It also provides it for SpCells (MCG and SCG) upon reconfiguration with sync.

ServingCellConfigCommon information element

| | |
|---|---|
| ServingCellConfigCommon ::= | SEQUENCE { |
| physCellId | PhysCellId |

OPTIONAL, -- Cond HOAndServCellAdd,

| | |
|---|---|
| downlinkConfigCommon | DownlinkConfigCommon |

OPTIONAL, -- Cond HOAndServCellAdd

| | |
|---|---|
| uplinkConfigCommon | UplinkConfigCommon |

OPTIONAL, -- Need M

| | |
|---|---|
| supplementaryUplinkConfig | UplinkConfigCommon |

OPTIONAL, -- Need S

| | |
|---|---|
| n-TimingAdvanceOffset | ENUMERATED { n0, n25600, n39936 } |

OPTIONAL, -- Need S

| | |
|---|---|
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |

}
OPTIONAL, -- Cond AbsFreqSSB

| | |
|---|---|
| ssb-periodicityServingCell | ENUMERATED { ms5, ms10, ms20, ms40, ms80, ms160, spare2, |

spare1 } OPTIONAL, -- Need S

| | |
|---|---|
| dmrs-TypeA-Position | ENUMERATED {pos2, pos3}, |
| lte-CRS-ToMatchAround | SetupRelease { RateMatchPatternLTE-CRS } |

OPTIONAL, -- Need M

| | |
|---|---|
| rateMatchPatternToAddModList | SEQUENCE (SIZE (1..maxNrofRateMatchPatterns)) OF |

RateMatchPattern OPTIONAL, -- Need N

| | |
|---|---|
| rateMatchPatternToReleaseList | SEQUENCE (SIZE (1..maxNrofRateMatchPatterns)) OF |

RateMatchPatternId OPTIONAL, -- Need N

| | |
|---|---|
| ssbSubcarrierSpacing | SubcarrierSpacing |

OPTIONAL, -- Cond HOAndServCellWithSSB

| | |
|---|---|
| tdd-UL-DL-ConfigurationCommon | TDD-UL-DL-ConfigCommon |

OPTIONAL, -- Cond TDD

| | |
|---|---|
| ss-PBCH-BlockPower | INTEGER (−60..50), |

[...]

| | |
|---|---|
| uplinkConfigCommon-v1700 | UplinkConfigCommon-v1700 |

OPTIONAL, -- Need R

| | |
|---|---|
| ntn-Config-r17 | NTN-Config-r17 |

OPTIONAL -- Need R
,

| | |
|---|---|
| featurePriorities-r17 | SEQUENCE { |
| redCapPriority-r17 | FeaturePriority-r17 |

OPTIONAL, -- Need R

| | |
|---|---|
| slicingPriority-r17 | FeaturePriority-r17 |

OPTIONAL, -- Need R

| | |
|---|---|
| msg3-Repetitions-Priority-r17 | FeaturePriority-r17 |

OPTIONAL, -- Need R

| | |
|---|---|
| sdt-Priority-r17 | FeaturePriority-r17 |

OPTIONAL -- Need R
}
OPTIONAL -- Need R
}

ServingCellConfigCommon field descriptions

downlinkConfigCommon
The common downlink configuration of the serving cell, including the frequency information configuration and the initial
downlink BWP common configuration. The parameters provided herein should match the parameters configured by MIB
and SIB1 (if provided) of the serving cell, with the exception of controlResourceSetZero and searchSpaceZero which can
be configured in ServingCellConfigCommon even if MIB indicates that they are absent.
supplementaryUplinkConfig
The network configures this field only if uplinkConfigCommon is configured. If this field is absent, the UE shall release the
supplementaryUplinkConfig and the supplementaryUplink configured in ServingCellConfig of this serving cell, if
configured.

### HandoverCommand

This message is used to transfer the handover command as generated by the target gNB.
Direction: target gNB to source gNB/source RAN.

HandoverCommand message

| | |
|---|---|
| HandoverCommand ::= | SEQUENCE |
| criticalExtensions | CHOICE { |
| c1 | CHOICE { |
| handoverCommand | HandoverCommand-IEs, |

```
      spare3 NULL, spare2 NULL, spare1 NULL
    },
```

| | |
|---|---|
| criticalExtensionsFuture | SEQUENCE { } |

}
}

| | |
|---|---|
| HandoverCommand-IEs ::= | SEQUENCE { |
| handoverCommandMessage | OCTET STRING (CONTAINING RRCReconfiguration), |
| nonCriticalExtension | SEQUENCE { } OPTIONAL |

}

HandoverCommand field descriptions

handoverCommandMessage
Contains the RRCReconfiguration message used to perform
handover within NR or handover to NR, as generated
(entirely) by the target gNB.

### HandoverPreparationInformation

This message is used to transfer the NR RRC information used by the target gNB during handover preparation or UE context retrieval, e.g. in case of resume or re-establishment, including UE capability information. This message is also used for transferring the information between the CU and DU.
Direction: source gNB/source RAN to target gNB or CU to DU.

HandoverPreparationInformation message

| | |
|---|---|
| HandoverPreparationInformation ::= | SEQUENCE { |
| criticalExtensions | CHOICE { |
| c1 | CHOICE{ |

```
      handoverPreparationInformation HandoverPreparationInformation-IEs,
      spare3 NULL, spare2 NULL, spare1 NULL
    },
```

| | |
|---|---|
| criticalExtensionsFuture | SEQUENCE { } |

}
}
HandoverPreparationInformation-IEs ::= SEQUENCE {

| ue-CapabilityRAT-List | UE-CapabilityRAT-ContainerList, | |
|---|---|---|
| sourceConfig | AS-Config | OPTIONAL, |

-- Cond HO

| | | |
|---|---|---|
| rrm-Config | RRM-Config | OPTIONAL, |
| as-Context | AS-Context | OPTIONAL, |
| nonCriticalExtension | SEQUENCE { } | OPTIONAL |

}

| | |
|---|---|
| AS-Config ::= | SEQUENCE { |
| rrcReconfiguration | OCTET STRING (CONTAINING RRCReconfiguration), |

[...]

| | | |
|---|---|---|
| sdt-Config-r17 | SDT-Config-r17 | OPTIONAL |

}

| | |
|---|---|
| AS-Context ::= | SEQUENCE { |
| reestablishmentInfo | Reestablishment Info |

OPTIONAL,

| | |
|---|---|
| configRestrictInfo | ConfigRestrictInfoSCG |

OPTIONAL,
[...]

| | |
|---|---|
| [[ ueAssistanceInformation | OCTET STRING (CONTAINING UEAssistanceInformation) |

OPTIONAL -- Cond HO2
]],

| | |
|---|---|
| selectedBandCombinationSN | BandCombinationInfoSN |

OPTIONAL
[...]

| | |
|---|---|
| mbsInterestIndication-r17 | OCTET STRING (CONTAINING MBSInterest Indication-r17) |

OPTIONAL
}
[...]

| ReestablishmentInfo ::= | SEQUENCE { | |
|---|---|---|
| sourcePhysCellId | PhysCellId, | |
| targetCellShortMAC-I | ShortMAC-I, | |
| additionalReestabInfoList | ReestabNCellInfoList | OPTIONAL |

}

| | |
|---|---|
| ReestabNCellInfoList ::= | SEQUENCE ( SIZE (1..maxCellPrep) ) OF ReestabNCellInfo |

ReestabNCellInfo::= SEQUENCE{

| | |
|---|---|
| cellIdentity | CellIdentity, |
| key-gNodeB-Star | BIT STRING (SIZE (256)), |
| shortMAC-I | ShortMAC-I |

}
RRM-Config ::= SEQUENCE {

| ue-InactiveTime | ENUMERATED { | |
|---|---|---|
| | s1, s2, s3, s5, s7, s10, s15, s20, | |
| | s25, s30, s40, s50, min1, min1s20, min1s40, | |
| | min2, min2s30, min3, min3s30, min4, min5, min6, | |
| | min7, min8, min9, min10, min12, min14, min17, min20, | |
| | min24, min28, min33, min38, min44, min50, hr1, | |
| | hr1min30, hr2, hr2min30, hr3, hr3min30, hr4, hr5, hr6, | |
| | hr8, hr10, hr13, hr16, hr20, day1, day1hr12, day2, | |
| | day2hr12, day3, day4, day5, day7, day10, day14, day19, | |
| | day24, day30, dayMoreThan30} | OPTIONAL, |
| candidateCellInfoList | MeasResultList2NR | OPTIONAL, |

[...]
}

HandoverPreparationInformation field descriptions

as-Context
Local RAN context required by the target gNB or DU.
rrm-Config
Local RAN context used mainly for RRM purposes.
sourceConfig
The radio resource configuration as used in the source cell.
ue-CapabilityRAT-List
The UE radio access related capabilities concerning RATs supported by the UE. A gNB that retrieves MRDC related
capability containers ensures that the set of included MRDC containers is consistent w.r.t. the feature set related
information.
ue-InactiveTime
Duration while UE has not received or transmitted any user data. Thus the timer is still running in case e.g., UE
measures the neighbour cells for the HO purpose. Value s 1 corresponds to 1 second, s 2 corresponds to 2 seconds and
so on. Value min 1 corresponds to 1 minute, value min 1 s 20 corresponds to 1 minute and 20 seconds, value min 1 s 40
corresponds to 1 minute and 40 seconds and so on. Value hr 1 corresponds to 1 hour, hr 1 min 30 corresponds to 1 hour
and 30 minutes and so on.

AS-Config field descriptions

rrcReconfiguration
Contains the RRCReconfiguration configuration
as generated entirely by the MN.
sdt-Config
Contains the IE SDT-Config as generated entirely by the
last serving gNB. This field is only used during the SDT
procedure with UE context relocation as defined
in TS 38.300 [2], clause 18.2.
sourceRB-SN-Config
Contains the IE RadioBearerConfig as generated entirely by the SN.
This field is only used when the UE is configured
with SN terminated RB(s).

AS-Context field descriptions

mbsInterestIndication
Includes the information last reported by the UE in the
NR MBSInterestIndication message, where the plmn-Index (if
included by the UE in tmgi) is replaced by the PLMN ID, if any.
needForGapsInfoNR
Includes measurement gap requirement information
of the UE for NR target bands.
ueAssistanceInformation
Includes for each UE assistance feature the information
last reported by the UE, if any.

RRM-Config field descriptions

candidateCellInfoList
A list of the best cells on each frequency for
which measurement information was available
candidateCellInfoListSN-EUTRA
A list of EUTRA cells including serving cells and best
neighbour cells on each serving frequency, for which measurement
results were available. This field is only used in NE-DC.

### Quotation End

The procedure and configurations for handover preparation are specified in TS 38.423 ([5] 3GPP TS 38.423 V17.2.0, “NG-RAN, Xn application protocol (XnAP).”) as provided below:

### Quotation Start [5]

### 8.2.1 Handover Preparation

### 8.2.1.1 General

This procedure is used to establish necessary resources in an NG-RAN node for an incoming handover. If the procedure concerns a conditional handover, parallel transactions are allowed. Possible parallel requests are identified by the target cell ID when the source UE AP IDs are the same.

The procedure uses UE-associated signalling.

### 8.2.1.2 Successful Operation

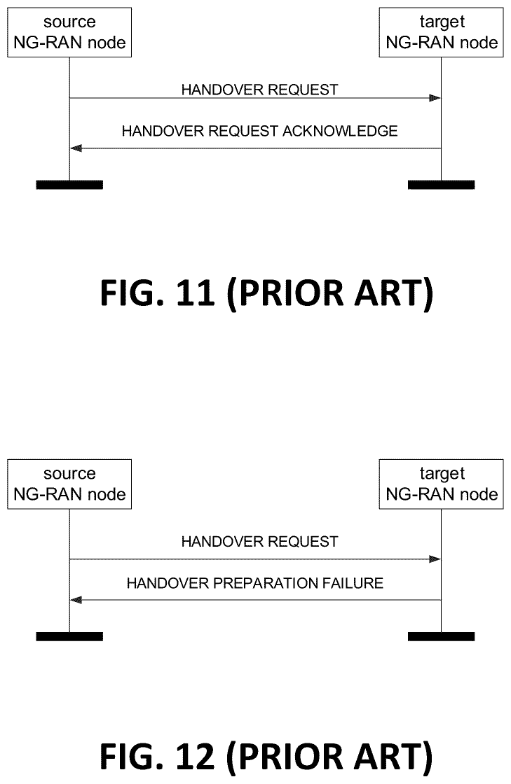

FIG. 11 is a reproduction of Figure 8.2.1.2-1: Handover Preparation, successful operation, from 3GPP TS 38.423 V17.2.0, “NG-RAN, Xn application protocol (XnAP).”

The source NG-RAN node initiates the procedure by sending the HANDOVER REQUEST message to the target NG-RAN node. When the source NG-RAN node sends the HANDOVER REQUEST message, it shall start the timer TXn_{RELOCprep}.

If the Conditional Handover Information Request IE is contained in the HANDOVER REQUEST message, the target NG-RAN node shall consider that the request concerns a conditional handover and shall include the Conditional Handover Information Acknowledge IE in the HANDOVER REQUEST ACKNOWLEDGE message.

If the Target NG-RAN node UE XnAP ID IE is contained in the Conditional Handover Information Request IE included in the HANDOVER REQUEST message, then the target NG-RAN node shall remove the existing prepared conditional HO identified by the Target NG-RAN node UE XnAP ID IE and the Target Cell Global ID IE. It is up to the implementation of the target NG-RAN node when to remove the HO information.

Upon reception of the HANDOVER REQUEST ACKNOWLEDGE message, the source NG-RAN node shall stop the timer TXn_{RELOCprep} and terminate the Handover Preparation procedure. If the procedure was initiated for an immediate handover, the source NG-RAN node shall start the timer TXn_{RELOCoverall}. The source NG-RAN node is then defined to have a Prepared Handover for that Xn UE-associated signalling.

At reception of the HANDOVER REQUEST message the target NG-RAN node shall prepare the configuration of the AS security relation between the UE and the target NG-RAN node by using the information in the UE Security Capabilities IE and the AS Security Information IE in the UE Context Information IE, as specified in TS 33.501 [28].

For each PDU session resource successfully setup at the target NG-RAN, the target NG-RAN node may allocate resources for additional Xn-U PDU session resource GTP-U tunnels, indicated in the Secondary Data Forwarding Info from target NG-RAN node List IE.

For each PDU session in the HANDOVER REQUEST message, if the Alternative QoS Parameters Set List IE is included in the GBR QoS Flow Information IE in the PDU Session Resources To Be Setup List IE, the target NG-RAN node may accept the setup of the involved QoS flow when notification control has been enabled if the requested QoS parameters set or at least one of the alternative QoS parameters sets can be fulfilled at the time of handover as specified in TS 23.501 [7]. In case the target NG-RAN node accepts the handover fulfilling one of the alternative QoS parameters it shall indicate the alternative QoS parameters set which it can currently fulfil in the Current QoS Parameters Set Index IE within the PDU Session Resources Admitted List IE of the HANDOVER REQUEST ACKNOWLEDGE message while setting the QoS parameters towards the UE according to the requested QoS parameters set as specified in TS 23.501 [7].

For each DRB for which the source NG-RAN node proposes to perform forwarding of downlink data, the source NG-RAN node shall include the DRB ID IE and the mapped QoS Flows List IE within the Source DRB to QoS Flow Mapping List IE contained in the PDU Session Resources To Be Setup List IE in the HANDOVER REQUEST message. The source NG-RAN node may include the QoS Flow Mapping Indication IE in the Source DRB to QoS Flow Mapping List IE to indicate that only the uplink or downlink QoS flow is mapped to the DRB. If the target NG-RAN node decides to use the same DRB configuration and to map the same QoS flows as the source NG-RAN node, the target NG-RAN node includes the DL Forwarding GTP Tunnel Endpoint IE within the Data Forwarding Response DRB List IE in the HANDOVER REQUEST ACKNOWLEDGE message to indicate that it accepts the proposed forwarding of downlink data for this DRB.

The target NG-RAN node may additionally include the Redundant DL Forwarding UP TNL Information IE if at least one of the QoS flow mapped to the DRB is eligible to the redundant transmission feature as indicated in the Redundant QoS Flow Indicator IE within the PDU Session Resource To Be Setup List IE received in the HANDOVER REQUEST message for the QoS flow.

If the HANDOVER REQUEST ACKNOWLEDGE message contains the UL Forwarding UP TNL Information IE for a given DRB in the Data Forwarding Response DRB List IE within Data Forwarding Info from target NG-RAN node IE in the PDU Session Resources Admitted List IE and the source NG-RAN node accepts the data forwarding proposed by the target NG-RAN node, the source NG-RAN node shall perform forwarding of uplink data for the DRB.

If the HANDOVER REQUEST includes PDU session resources for PDU sessions associated to S-NSSAIs not supported by target NG-RAN, the target NG-RAN node shall reject such PDU session resources. In this case, and if at least one PDU Session Resource To Be Setup Item IE is admitted, the target NG-RAN node shall send the HANDOVER REQUEST ACKNOWLEDGE message including the PDU Session Resources Not Admitted List IE listing corresponding PDU sessions rejected at the target NG-RAN.

If the Mobility Restriction List IE is
contained in the HANDOVER REQUEST message, the target NG-RAN node shall
   store the information received in the Mobility Restriction List IE in the UE context;
   use this information to determine a target for the UE during subsequent mobility action for which the NG-RAN node provides information about the target of the mobility action towards the UE, except when one of the PDU sessions has a particular ARP value (TS 23.501 [7]) in which case the information shall not apply;
   use this information to select a proper SCG during dual connectivity operation.
   use this information to select proper RNA(s) for the UE when moving the UE to RRC_INACTIVE.
not contained in the HANDOVER REQUEST message, the target NG-RAN node shall
   consider that no roaming and no access restriction apply to the UE except for the PNI-NPN mobility as described in TS 23.501 [7].

If the Index to RAT/Frequency Selection Priority IE is contained in the HANDOVER REQUEST message, the target NG-RAN node shall store this information and use it as defined in TS 23.501 [7].

If the UE Context Reference at the S-NG-RAN IE is contained in the HANDOVER REQUEST message the target NG-RAN node may use it as specified in TS 37.340 [8]. In this case, the source NG-RAN node may expect the target NG-RAN node to include the UE Context Kept Indicator IE set to “True” in the HANDOVER REQUEST ACKNOWLEDGE message, which shall use this information as specified in TS 37.340 [8].

For each PDU session for which the Security Indication IE is included in the PDU Session Resource To Be Setup List IE and the Integrity Protection Indication IE or Confidentiality Protection Indication IE is set to “required”, the target NG-RAN node shall perform user plane integrity protection or ciphering, respectively. If the NG-RAN node is not able to perform the user plane integrity protection or ciphering, it shall reject the setup of the PDU Session Resources with an appropriate cause value.

If the NG-RAN node is an ng-eNB, it shall reject all PDU sessions for which the Integrity Protection Indication IE is set to “required”.

For each PDU session for which the Security Indication IE is included in the PDU Session Resource To Be Setup List IE and the Integrity Protection Indication IE or the Confidentiality Protection Indication IE is set to “preferred”, the target NG-RAN node should, if supported, perform user plane integrity protection or ciphering, respectively and shall notify the SMF whether it succeeded the user plane integrity protection or ciphering or not for the concerned security policy.

For each PDU session for which the Maximum Integrity Protected Data Rate IE is included in the Security Indication IE in the PDU Session Resources To Be Setup List IE, the NG-RAN node shall store the respective information and, if integrity protection is to be performed for the PDU session, it shall enforce the traffic corresponding to the received Maximum Integrity Protected Data Rate IE, for the concerned PDU session and concerned UE, as specified in TS 23.501 [7].

For each PDU session for which the Security Indication IE is included in the PDU Session Resource To Be Setup List IE and the Integrity Protection Indication IE or Confidentiality Protection Indication IE is set to “not needed”, the target NG-RAN node shall not perform user plane integrity protection or ciphering, respectively, for the concerned PDU session.

For each PDU session, if the Additional UL NG-U UP TNL Information List IE is included in the PDU Session Resources To Be Setup List IE contained in the HANDOVER REQUEST message, the target NG-RAN node may forward the UP transport layer information to the target S-NG-RAN node as the uplink termination point for the user plane data for this PDU session split in different tunnel.

If the Location Reporting Information IE is included in the HANDOVER REQUEST message, then the target NG-RAN node should initiate the requested location reporting functionality as defined in TS 38.413 [5].

Upon reception of UE History Information IE in the HANDOVER REQUEST message, the target NG-RAN node shall collect the information defined as mandatory in the UE History Information IE and shall, if supported, collect the information defined as optional in the UE History Information IE, for as long as the UE stays in one of its cells, and store the collected information to be used for future handover preparations.

If the HANDOVER REQUEST message includes the Management Based MDT PLMN List IE, the target NG-RAN node shall, if supported, store it in the UE context, and take it into account if it includes information regarding the PLMN serving the UE in the target NG-RAN node.

If the Mobility Information IE is provided in the HANDOVER REQUEST message, the target NG-RAN node shall, if supported, store this information. The target NG-RAN shall, if supported, store the C-RNTI assigned at the source cell as received in the HANDOVER REQUEST message.

Upon reception of the UE History Information from the UE IE in the HANDOVER REQUEST message, the target NG-RAN node shall, if supported, store the collected information and use it for future handover preparations.

For each QoS flow which has been successfully established in the target NG-RAN node, if the QoS Monitoring Request IE was included in the QoS Flow Level QoS Parameters IE contained in the HANDOVER REQUEST message, the target NG-RAN node shall store this information, and shall, if supported, perform delay measurement and QoS monitoring, as specified in TS 23.501 [7]. If the QoS Monitoring Reporting Frequency IE was included in the QoS Flow Level QoS Parameters IE contained in the HANDOVER REQUEST message, the target NG-RAN node shall store this information, and shall, if supported, use it for RAN part delay reporting.

If the 5GC Mobility Restriction List Container IE is included in the HANDOVER REQUEST message, the target NG-RAN node shall, if supported, store this information in the UE context and use it as specified in TS 38.300 [9].

If the Maximum Number of CHO Preparations IE is included in the Conditional Handover Information Acknowledge IE contained in the HANDOVER REQUEST ACKNOWLEDGE message, then the source NG-RAN node should not prepare more candidate target cells for a CHO for the same UE towards the target NG-RAN node than the number indicated in the IE.

If the Estimated Arrival Probability IE is contained in the Conditional Handover Information Request IE included in the HANDOVER REQUEST message, then the target NG-RAN node may use the information to allocate necessary resources for the incoming CHO.

If the UE Radio Capability ID IE is contained in the HANDOVER REQUEST message, the target NG-RAN node shall, if supported, store this information in the UE context and use it as defined in TS 23.501 [7] and TS 23.502 [13].

If for a given QoS Flow the Source DL Forwarding IP Address IE is included within the Data Forwarding and Offloading Info from source NG-RAN node IE in the PDU Session Resources To Be Setup List IE contained in the HANDOVER REQUEST message, the target NG-RAN node shall, if supported, store this information and use it as part of its ACL functionality configuration actions, if such ACL functionality is deployed.

If the Time Synchronisation Assistance Information IE is contained in the HANDOVER REQUEST message, the target NG-RAN node shall, if supported, store this information in the UE context and use it as defined in TS 23.501 [7].

If the QMC Configuration Information IE is contained in the HANDOVER REQUEST message, the target NG-RAN node shall, if supported, take it into account for QoE measurements handling, as described in TS 38.300 [9].

If the UE Slice-Maximum Bit Rate List IE is contained in HANDOVER REQUEST message, the target NG-RAN node shall, if supported, store the received UE Slice Maximum Bit Rate List in the UE context, and use the received UE Slice Maximum Bit Rate value for each S-NSSAI for the concerned UE as specified in TS 23.501 [7].

### 8.2.1.3 Unsuccessful Operation

FIG. 12 is a reproduction of Figure 8.2.1.3-1: Handover Preparation, unsuccessful operation, from 3GPP TS 38.423 V17.2.0, “NG-RAN, Xn application protocol (XnAP).”

If the target NG-RAN node does not admit at least one PDU session resource, or a failure occurs during the Handover Preparation, the target NG-RAN node shall send the HANDOVER PREPARATION FAILURE message to the source NG-RAN node. The message shall contain the Cause IE with an appropriate value.

If the Conditional Handover Information Request IE is contained in the HANDOVER REQUEST message and the target NG-RAN node rejects the handover or a failure occurs during the Handover Preparation, the target NG-RAN node shall include the Requested Target Cell ID IE in the HANDOVER PREPARATION FAILURE message.

Interactions with Handover Cancel Procedure:

If there is no response from the target NG-RAN node to the HANDOVER REQUEST message before timer TXn_{RELOCprep} expires in the source NG-RAN node, the source NG-RAN node should cancel the Handover Preparation procedure towards the target NG-RAN node by initiating the Handover Cancel procedure with the appropriate value for the Cause IE. The source NG-RAN node shall ignore any HANDOVER REQUEST ACKNOWLEDGE or HANDOVER PREPARATION FAILURE message received after the initiation of the Handover Cancel procedure and remove any reference and release any resources related to the concerned Xn UE-associated signalling.

### Next Quotation

### 9.1.1.1 Handover Request

This message is sent by the source NG-RAN node to the target NG-RAN node to request the preparation of resources for a handover.

Direction: source NG-RAN node→target NG-RAN node.

| | | | IV- | V- | VI- | VII- |
|---|---|---|---|---|---|---|
| I- | II- | III- | IE type and | Semantics | Criti- | Assigned |
| IE/Group Name | Presence | Range | reference | description | cality | Criticality |
| Message Type | M | | 9.2.3.1 | | YES | reject |
| Source NG-RAN node UE | M | | NG-RAN | Allocated at the | YES | reject |
| XnAP ID reference | | | node UE | source NG-RAN | | |
| | | | XnAP ID | node | | |
| | | | 9.2.3.16 | | | |
| Cause | M | | 9.2.3.2 | | YES | reject |
| Target Cell Global ID | M | | 9.2.3.25 | Includes either an | YES | reject |
| | | | | E-UTRA CGI or an | | |
| | | | | NR CGI | | |
| GUAMI | M | | 9.2.3.24 | | YES | reject |
| UE Context Information | | 1 | | | YES | reject |
| >NG-C UE associated | M | | AMF UE | Allocated at the | — | |
| Signalling reference | | | NGAP ID | AMF on the source | | |
| | | | 9.2.3.26 | NG-C connection. | | |
| >Signalling TNL association | M | | CP | This IE indicates | — | |
| address at source | | | Transport | the AMF's IP | | |
| NG-C side | | | Layer | address of the | | |
| | | | Information | SCTP association | | |
| | | | 9.2.3.31 | used at the source | | |
| | | | | NG-C interface | | |
| | | | | instance. | | |
| | | | | Note: If no UE | | |
| | | | | TNLA binding | | |
| | | | | exists at the source | | |
| | | | | NG-RAN node, the | | |
| | | | | source NG-RAN | | |
| | | | | node indicates the | | |
| | | | | TNL association | | |
| | | | | address it would | | |
| | | | | have selected if it | | |
| | | | | would have had to | | |
| | | | | create a UE TNLA | | |
| | | | | binding. | | |
| >UE Security Capabilities | M | | 9.2.3.49 | | — | |
| >AS Security Information | M | | 9.2.3.50 | | — | |
| >Index to RAT/Frequency | O | | 9.2.3.23 | | — | |
| Selection Priority | | | | | | |
| >UE Aggregate Maximum | M | | 9.2.3.17 | | — | |
| Bit Rate | | | | | | |
| >PDU Session Resources | | 1 | 9.2.1.1 | Similar to NG-C | — | |
| To Be Setup List | | | | signalling, | | |
| | | | | containing UL | | |
| | | | | tunnel information | | |
| | | | | per PDU Session | | |
| | | | | Resource; | | |
| | | | | and in addition, the | | |
| | | | | source side QoS | | |
| | | | | flow ⇔ DRB | | |
| | | | | mapping | | |
| >RRC Context | M | | OCTET | Either includes the | — | |
| | | | STRING | HandoverPreparati | | |
| | | | | onInformation | | |
| | | | | message as | | |
| | | | | defined in | | |
| | | | | subclause 10.2.2. | | |
| | | | | of TS 36.331 [14], | | |
| | | | | or the | | |
| | | | | HandoverPreparati | | |
| | | | | onInformation-NB | | |
| | | | | message as | | |
| | | | | defined in | | |
| | | | | subclause 10.6.2 of | | |
| | | | | TS 36.331 [14], if | | |
| | | | | the target NG-RAN | | |
| | | | | node is an ng-eNB, | | |
| | | | | or the | | |
| | | | | HandoverPreparati | | |
| | | | | onInformation | | |
| | | | | message as | | |
| | | | | defined in | | |
| | | | | subclause 11.2.2 of | | |
| | | | | TS 38.331 [10], if | | |
| | | | | the target NG-RAN | | |
| | | | | node is a gNB. | | |
| >Location Reporting | O | | 9.2.3.47 | Includes the | — | |
| Information | | | | necessary | | |
| | | | | parameters for | | |
| | | | | location reporting. | | |
| >Mobility Restriction List | O | | 9.2.3.53 | | — | |
| >5GC Mobility Restriction | O | | 9.2.3.100 | | YES | ignore |
| List Container | | | | | | |
| >NR UE Sidelink Aggregate | O | | 9.2.3.107 | This IE applies only | YES | ignore |
| Maximum Bit Rate | | | | if the UE is | | |
| | | | | authorized for NR | | |
| | | | | V2X services. | | |
| >LTE UE Sidelink | O | | 9.2.3.108 | This IE applies only | YES | ignore |
| Aggregate Maximum Bit | | | | if the UE is | | |
| Rate | | | | authorized for LTE | | |
| | | | | V2X services. | | |
| >Management Based MDT | O | | MDT PLMN | | YES | ignore |
| PLMN List | | | List | | | |
| | | | 9.2.3.133 | | | |
| >UE Radio Capability ID | O | | 9.2.3.138 | | YES | reject |
| >MBS Session Information | O | | 9.2.1.36 | | YES | ignore |
| List | | | | | | |
| >5G ProSe UE PC5 | O | | NR UE | This IE applies only | YES | ignore |
| Aggregate Maximum Bit | | | Sidelink | if the UE is | | |
| Rate | | | Aggregate | authorized for 5G | | |
| | | | Maximum Bit | ProSe services. | | |
| | | | Rate | | | |
| | | | 9.2.3.107 | | | |
| >UE Slice Maximum Bit | O | | 9.2.3.167 | | YES | ignore |
| Rate List | | | | | | |
| Trace Activation | O | | 9.2.3.55 | | YES | ignore |
| Masked IMEISV | O | | 9.2.3.32 | | YES | ignore |
| UE History Information | M | | 9.2.3.64 | | YES | ignore |
| UE Context Reference at | O | | | | YES | ignore |
| the S-NG-RAN node | | | | | | |
| >Global NG-RAN Node ID | M | | 9.2.2.3 | | — | |
| >S-NG-RAN node UE | M | | NG-RAN | | — | |
| XnAP ID | | | node UE | | | |
| | | | XnAP ID | | | |
| | | | 9.2.3.16 | | | |
| Conditional Handover | O | | | | YES | reject |
| Information Request | | | | | | |
| >CHO Trigger | M | | ENUMERATED | | — | |
| | | | (CHO- | | | |
| | | | initiation, | | | |
| | | | CHO- | | | |
| | | | replace, . . .) | | | |
| >Target NG-RAN node UE | C- | | NG-RAN | Allocated at the | — | |
| XnAP ID | ifCHOmod | | node UE | target NG-RAN | | |
| | | | XnAP ID | node | | |
| | | | 9.2.3.16 | | | |
| >Estimated Arrival | O | | INTEGER | | — | |
| Probability | | | (1 . . . 100) | | | |
| NR V2X Services Authorized | O | | 9.2.3.105 | | YES | ignore |
| LTE V2X Services | O | | 9.2.3.106 | | YES | ignore |
| Authorized | | | | | | |
| PC5 QoS Parameters | O | | 9.2.3.109 | This IE applies only | YES | ignore |
| | | | | if the UE is | | |
| | | | | authorized for NR | | |
| | | | | V2X services. | | |
| Mobility Information | O | | BIT STRING | Information related | YES | ignore |
| | | | (SIZE (32)) | to the handover; | | |
| | | | | the source NG- | | |
| | | | | RAN node provides | | |
| | | | | it in order to enable | | |
| | | | | later analysis of the | | |
| | | | | conditions that led | | |
| | | | | to a wrong HO. | | |
| UE History Information from | O | | 9.2.3.110 | | YES | ignore |
| the UE | | | | | | |
| IAB Node Indication | O | | ENUMERATED | | YES | reject |
| | | | (true, . . .) | | | |
| No PDU Session Indication | O | | ENUMERATED | This IE applies only | YES | ignore |
| | | | (true, . . .) | if the UE is an IAB- | | |
| | | | | MT. | | |
| Time Synchronisation | O | | 9.2.3.153 | | YES | ignore |
| Assistance Information | | | | | | |
| QMC Configuration | O | | 9.2.3.156 | | YES | ignore |
| Information | | | | | | |
| 5G ProSe Authorized | O | | 9.2.3.159 | | YES | ignore |
| 5G ProSe PC5 QoS | O | | 9.2.3.160 | This IE applies only | YES | ignore |
| Parameters | | | | if the UE is | | |
| | | | | authorized for 5G | | |
| | | | | ProSe services. | | |

| VIII- Condition | IX- Explanation |
|---|---|
| ifCHOmod | This IE shall be present if the CHO |
| | Trigger IE is present and set to “CHO-replace”. |

| X- Range bound | XI- Explanation |
|---|---|
| maxnoofMDTPLMNs | PLMNs in the Management |
| | Based MDT PLMN list. Value is 16. |

### 9.1.1.2 Handover Request Acknowledge

This message is sent by the target NG-RAN node to inform the source NG-RAN node about the prepared resources at the target.

Direction: target NG-RAN node→source NG-RAN node.

| | XIII- | | XV- | XVI- | XVII- | XVIII- |
|---|---|---|---|---|---|---|
| XII- | Pres- | XIV- | IE type | Semantics | Criti- | Assigned |
| IE/Group Name | ence | Range | and reference | description | cality | Criticality |
| Message Type | M | | 9.2.3.1 | | YES | reject |
| Source NG-RAN node UE | M | | NG-RAN node | Allocated at the | YES | ignore |
| XnAP ID | | | UE XnAP ID | source NG-RAN node | | |
| | | | 9.2.3.16 | | | |
| Target NG-RAN node UE | M | | NG-RAN node | Allocated at the target | YES | ignore |
| XnAP ID | | | UE XnAP ID | NG-RAN node | | |
| | | | 9.2.3.16 | | | |
| PDU Session Resources | M | | 9.2.1.2 | | YES | ignore |
| Admitted List | | | | | | |
| PDU Session Resources Not | O | | 9.2.1.3 | | YES | ignore |
| Admitted List | | | | | | |
| Target NG-RAN node To | M | | OCTET | Either includes the | YES | ignore |
| Source NG-RAN node | | | STRING | HandoverCommand | | |
| Transparent Container | | | | message as defined | | |
| | | | | in subclause 10.2.2 of | | |
| | | | | TS 36.331 [14], if the | | |
| | | | | target NG-RAN node | | |
| | | | | is an ng-eNB, | | |
| | | | | or the | | |
| | | | | HandoverCommand | | |
| | | | | message as defined | | |
| | | | | in subclause 11.2.2 of | | |
| | | | | TS 38.331 [10], if the | | |
| | | | | target NG-RAN node | | |
| | | | | is a gNB. | | |
| UE Context Kept Indicator | O | | 9.2.3.68 | | YES | ignore |
| Criticality Diagnostics | O | | 9.2.3.3 | | YES | ignore |
| DRBs transferred to MN | O | | DRB List | In case of DC, | YES | ignore |
| | | | 9.2.1.29 | indicates that SN | | |
| | | | | Status is needed for | | |
| | | | | the listed DRBs from | | |
| | | | | the S-NG-RAN node. | | |
| DAPS Response Information | O | | 9.2.1.34 | | YES | reject |
| Conditional Handover | O | | | | YES | reject |
| Information Acknowledge | | | | | | |
| >Requested Target Cell ID | M | | Target Cell | Target cell indicated | — | |
| | | | Global ID | in the corresponding | | |
| | | | 9.2.3.25 | HANDOVER | | |
| | | | | REQUEST message | | |
| >Maximum Number of CHO | O | | 9.2.3.101 | | — | |
| Preparations | | | | | | |
| MBS Session Information | O | | 9.2.1.38 | | YES | ignore |
| Response List | | | | | | |

### 9.2.2.7 NR CGI

This IE is used to globally identify an NR cell (see TS 38.300 [9]).

| | | | | |
|---|---|---|---|---|
| | | | XXII- | XXIII- |
| XIX- IE/ | XX- | XXI- | IE type and | Semantics |
| Group Name | Presence | Range | reference | description |

| | | | |
|---|---|---|---|
| PLMN Identity | M | 9.2.2.4 | |
| NR Cell | M | BIT STRING | The leftmost bits |
| Identity | | (SIZE(36)) | of the NR Cell |
| | | | Identity IE |
| | | | correspond to the |
| | | | gNB ID (defined |
| | | | in subclause |
| | | | 9.2.2.1). |

### 9.2.3.25 Target Cell Global ID

This IE contains either an NR CGI or an E-UTRA CGI.

| | | | | |
|---|---|---|---|---|
| | | | XXVII- | XXVIII- |
| XXIV-IE/ | XXV- | XXVI- | IE type and | Semantics |
| Group Name | Presence | Range | reference | description |

| | | |
|---|---|---|
| CHOICE Target Cell | M | |
| >NR | | |
| >>NR CGI | M | 9.2.2.7 |
| >E-UTRA | | |
| >>E-UTRA CGI | M | 9.2.2.8 |

### 8.4.1 Xn Setup

### 8.4.1.1 General

The purpose of the Xn Setup procedure is to exchange application level configuration data needed for two NG-RAN nodes to interoperate correctly over the Xn-C interface.

The procedure uses non UE-associated signalling.

### 8.4.1.2 Successful Operation

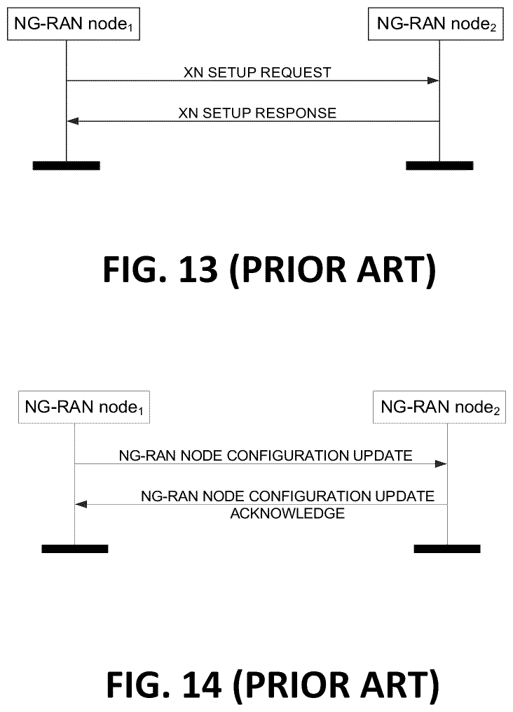

FIG. 13 is a reproduction of Figure 8.4.1.2: Xn Setup, successful operation, from 3GPP TS 38.423 V17.2.0, “NG-RAN, Xn application protocol (XnAP).”

The NG-RAN node₁ initiates the procedure by sending the XN SETUP REQUEST message to the candidate NG-RAN node₂. The candidate NG-RAN node₂ replies with the XN SETUP RESPONSE message.

### Next Quotation

8.4.2 NG-RAN node Configuration Update

### 8.4.2.1 General

The purpose of the NG-RAN node Configuration Update procedure is to update application level configuration data needed for two NG-RAN nodes to interoperate correctly over the Xn-C interface.
NOTE: Update of application level configuration data also applies between two NG-RAN nodes in case the SN (i.e. the gNB) does not broadcast system information other than for radio frame timing and SFN, as specified in the TS 37.340 [8]. How to use this information when this option is used is not explicitly specified.

The procedure uses non UE-associated signalling.

### 8.4.2.2 Successful Operation

FIG. 14 is a reproduction of Figure 8.4.2.2-1: NG-RAN node Configuration Update, successful operation, from 3GPP TS 38.423 V17.2.0, “NG-RAN, Xn application protocol (XnAP).”

The NG-RAN node₁ initiates the procedure by sending the NG-RAN NODE CONFIGURATION UPDATE message to a peer NG-RAN node₂.

### Quotation End

Handover preparation via NG interface is specified in TS 38.413 ([7] 3GPP TS 38.413 V17.2.0, “NG-RAN, NG Application Protocol (NGAP)”):

### Quotation Start

### 8.4.1 Handover Preparation

### 8.4.1.1 General

The purpose of the Handover Preparation procedure is to request the preparation of resources at the target side via the 5GC. There is only one Handover Preparation procedure ongoing at the same time for a certain UE. The procedure uses UE-associated signalling.

### 8.4.1.2 Successful Operation

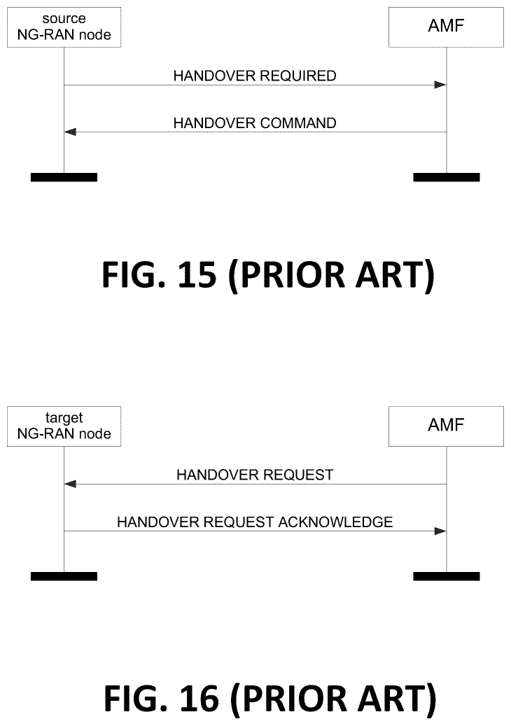

FIG. 15 is a reproduction of Figure 8.4.1.2-1: Handover preparation: successful operation, from 3GPP TS 38.413 V17.2.0, “NG-RAN, NG Application Protocol (NGAP)”

The source NG-RAN node initiates the handover preparation by sending the HANDOVER REQUIRED message to the serving AMF. When the source NG-RAN node sends the HANDOVER REQUIRED message, it shall start the timer TNG_{RELOcprep}. The source NG-RAN node shall indicate the appropriate cause value for the handover in the Cause IE.

Upon reception of the HANDOVER REQUIRED message the AMF shall, for each PDU session indicated in the PDU Session ID IE, transparently transfer the Handover Required Transfer IE to the SMF associated with the concerned PDU session.

In case of intra-system handover, the information in the Source to Target Transparent Container IE shall be encoded according to the definition of the Source NG-RAN node to Target NG-RAN node Transparent Container IE.

### Next Quotation

### 8.4.2 Handover Resource Allocation

### 8.4.2.1 General

The purpose of the Handover Resource Allocation procedure is to reserve resources at the target NG-RAN node for the handover of a UE. The procedure uses UE-associated signalling.

### 8.4.2.2 Successful Operation

FIG. 16 is a reproduction of Figure 8.4.2.2-1: Handover resource allocation: successful operation, from 3GPP TS 38.413 V17.2.0, “NG-RAN, NG Application Protocol (NGAP)” The AMF initiates the procedure by sending the HANDOVER REQUEST message to the target NG-RAN node.

### Next Quotation

### 9.2.3.1 Handover Required

This message is sent by the source NG-RAN node to the AMF to request the preparation of resources at the target.
Direction: NG-RAN node→AMF.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF UE NGAP ID | M | | 9.3.3.1 | | YES | reject |
| RAN UE NGAP ID | M | | 9.3.3.2 | | YES | reject |
| Handover Type | M | | 9.3.1.22 | | YES | reject |
| Cause | M | | 9.3.1.2 | | YES | ignore |
| Target ID | M | | 9.3.1.25 | | YES | reject |
| Direct Forwarding Path | O | | 9.3.1.64 | | YES | ignore |
| Availability | | | | | | |
| PDU Session | | 1 | | | YES | reject |
| Resource List | | | | | | |
| >PDU Session | | 1 . . . <maxno | | | — | |
| Resource Item | | ofPDUSes | | | | |
| | | sions> | | | | |
| >>PDU Session ID | M | | 9.3.1.50 | | — | |
| >>Handover Required | M | | OCTET | Containing the | — | |
| Transfer | | | STRING | Handover | | |
| | | | | Required Transfer | | |
| | | | | IE specified in | | |
| | | | | subclause | | |
| | | | | 9.3.4.14. | | |
| Source to Target | M | | 9.3.1.20 | | YES | reject |
| Transparent Container | | | | | | |

| Range bound | Explanation |
|---|---|
| maxnoofPDUSessions | Maximum no. of PDU sessions allowed |
| | towards one UE. Value is 256. |

### 9.2.3.2 Handover Command

This message is sent by the AMF to inform the source NG-RAN node that resources for the handover have been prepared at the target side.
Direction: AMF→NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF UE NGAP ID | M | | 9.3.3.1 | | YES | reject |
| RAN UE NGAP ID | M | | 9.3.3.2 | | YES | reject |
| Handover Type | M | | 9.3.1.22 | | YES | reject |
| NAS Security | C- | | 9.3.3.26 | | YES | reject |
| Parameters from NG- | iftoEPSUT | | | | | |
| RAN | RA | | | | | |
| PDU Session | | 0 . . . 1 | | | YES | Ignore |
| Resource Handover | | | | | | |
| List | | | | | | |
| >PDU Session | | 1 . . . <maxno | | | — | |
| Resource Handover | | ofPDUSes | | | | |
| Item | | sions> | | | | |
| >>PDU Session ID | M | | 9.3.1.50 | | — | |
| >>Handover | M | | OCTET | Containing the | — | |
| Command Transfer | | | STRING | Handover | | |
| | | | | Command | | |
| | | | | Transfer IE | | |
| | | | | specified in | | |
| | | | | subclause | | |
| | | | | 9.3.4.10. | | |
| PDU Session | | 0 . . . 1 | | | YES | ignore |
| Resource to Release | | | | | | |
| List | | | | | | |
| >PDU Session | | 1 . . . <maxno | | | — | |
| Resource to Release | | ofPDUSes | | | | |
| Item | | sions> | | | | |
| >>PDU Session ID | M | | 9.3.1.50 | | — | |
| >>Handover | M | | OCTET | Containing the | — | |
| Preparation | | | STRING | Handover | | |
| Unsuccessful | | | | Preparation | | |
| Transfer | | | | Unsuccessful | | |
| | | | | Transfer IE | | |
| | | | | specified in | | |
| | | | | subclause | | |
| | | | | 9.3.4.18. | | |
| Target to Source | M | | 9.3.1.21 | | YES | reject |
| Transparent Container | | | | | | |
| Criticality Diagnostics | O | | 9.3.1.3 | | YES | ignore |

| Range bound | Explanation |
|---|---|
| maxnoofPDUSessions | Maximum no. of PDU sessions |
| | allowed towards one UE. Value is 256. |

### 9.2.3.4 Handover Request

This message is sent by the AMF to the target NG-RAN node to request the preparation of resources.
Direction: AMF→NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF UE NGAP ID | M | | 9.3.3.1 | | YES | reject |
| Handover Type | M | | 9.3.1.22 | | YES | reject |
| Cause | M | | 9.3.1.2 | | YES | ignore |
| UE Aggregate Maximum | M | | 9.3.1.58 | | YES | reject |
| Bit Rate | | | | | | |
| Core Network Assistance | O | | 9.3.1.15 | | YES | ignore |
| Information for RRC | | | | | | |
| INACTIVE | | | | | | |
| UE Security Capabilities | M | | 9.3.1.86 | | YES | reject |
| Security Context | M | | 9.3.1.88 | | YES | reject |
| New Security Context | O | | 9.3.1.55 | | YES | reject |
| Indicator | | | | | | |
| NASC | O | | NAS-PDU | Refers to either the | YES | reject |
| | | | 9.3.3.4 | “Intra N1 mode | | |
| | | | | NAS transparent | | |
| | | | | container” or the | | |
| | | | | “S1 mode to N1 | | |
| | | | | mode NAS | | |
| | | | | transparent | | |
| | | | | container”, the | | |
| | | | | details of the IE | | |
| | | | | definition and the | | |
| | | | | encoding | | |
| | | | | arespecified in TS | | |
| | | | | 24.501 [26]. | | |
| PDU Session Resource | | 1 | | | YES | reject |
| Setup List | | | | | | |
| >PDU Session | | 1 . . . <maxno | | | — | |
| Resource Setup Item | | ofPDUSes | | | | |
| | | sions> | | | | |
| >>PDU Session ID | M | | 9.3.1.50 | | — | |
| >>S-NSSAI | M | | 9.3.1.24 | | — | |
| >>Handover Request | M | | OCTET STRING | Containing the | — | |
| Transfer | | | | PDU Session | | |
| | | | | Resource Setup | | |
| | | | | Request Transfer | | |
| | | | | IE specified in | | |
| | | | | subclause 9.3.4.1. | | |
| >>PDU Session | O | | Expected UE | Expected UE | YES | ignore |
| Expected UE Activity | | | Activity | Activity Behaviour | | |
| Behaviour | | | Behaviour | for the PDU | | |
| | | | 9.3.1.94 | Session. | | |
| Allowed NSSAI | M | | 9.3.1.31 | Indicates the S- | YES | reject |
| | | | | NSSAIs permitted | | |
| | | | | by the network. | | |
| Trace Activation | O | | 9.3.1.14 | | YES | ignore |
| Masked IMEISV | O | | 9.3.1.54 | | YES | ignore |
| Source to Target | M | | 9.3.1.20 | | YES | reject |
| Transparent Container | | | | | | |
| Mobility Restriction List | O | | 9.3.1.85 | | YES | ignore |
| Location Reporting | O | | 9.3.1.65 | | YES | ignore |
| Request Type | | | | | | |
| RRC Inactive Transition | O | | 9.3.1.91 | | YES | ignore |
| Report Request | | | | | | |
| GUAMI | M | | 9.3.3.3 | | YES | reject |
| Redirection for Voice | O | | 9.3.1.116 | | YES | ignore |
| EPS Fallback | | | | | | |
| CN Assisted RAN | O | | 9.3.1.119 | | YES | ignore |
| Parameters Tuning | | | | | | |
| SRVCC Operation | O | | 9.3.1.128 | | YES | ignore |
| Possible | | | | | | |
| IAB Authorized | O | | 9.3.1.129 | | YES | reject |
| Enhanced Coverage | O | | 9.3.1.140 | | YES | ignore |
| Restriction | | | | | | |
| UE Differentiation | O | | 9.3.1.144 | | YES | ignore |
| Information | | | | | | |
| NR V2X Services | O | | 9.3.1.146 | | YES | ignore |
| Authorized | | | | | | |
| LTE V2X Services | O | | 9.3.1.147 | | YES | ignore |
| Authorized | | | | | | |
| NR UE Sidelink | O | | 9.3.1.148 | This IE applies | YES | ignore |
| Aggregate Maximum Bit | | | | only if the UE is | | |
| Rate | | | | authorized for NR | | |
| | | | | V2X services. | | |
| LTE UE Sidelink | O | | 9.3.1.149 | This IE applies | YES | ignore |
| Aggregate Maximum Bit | | | | only if the UE is | | |
| Rate | | | | authorized for LTE | | |
| | | | | V2X services. | | |
| PC5 QoS Parameters | O | | 9.3.1.150 | This IE applies | YES | ignore |
| | | | | only if the UE is | | |
| | | | | authorized for NR | | |
| | | | | V2X services. | | |
| CE-mode-B Restricted | O | | 9.3.1.155 | | YES | ignore |
| UE User Plane CloT | O | | 9.3.1.160 | | YES | ignore |
| Support Indicator | | | | | | |
| Management Based MDT | O | | MDT PLMN List | | YES | ignore |
| PLMN List | | | 9.3.1.168 | | | |
| UE Radio Capability ID | O | | 9.3.1.142 | | YES | reject |
| Extended Connected | O | | 9.3.3.31 | | YES | ignore |
| Time | | | | | | |
| Time Synchronisation | O | | 9.3.1.220 | | YES | ignore |
| Assistance Information | | | | | | |
| UE Slice Maximum Bit | O | | 9.3.1.231 | | YES | ignore |
| Rate List | | | | | | |
| 5G ProSe Authorized | O | | 9.3.1.233 | | YES | ignore |
| 5G ProSe UE PC5 | O | | NR UE Sidelink | This IE applies | YES | ignore |
| Aggregate Maximum Bit | | | Aggregate | only if the UE is | | |
| Rate | | | Maximum Bit | authorized for 5G | | |
| | | | Rate | ProSe services. | | |
| | | | 9.3.1.148 | | | |
| 5G ProSe PC5 QoS | O | | 9.3.1.234 | This IE applies | YES | ignore |
| Parameters | | | | only if the UE is | | |
| | | | | authorized for 5G | | |
| | | | | ProSe services. | | |

| Range bound | Explanation |
|---|---|
| maxnoofPDUSessions | Maximum no. of PDU sessions |
| | allowed towards one UE. Value is 256. |

### 9.2.3.5 Handover Request Acknowledge

This message is sent by the target NG-RAN node to inform the AMF about the prepared resources at the target.
Direction: NG-RAN node→AMF.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF UE NGAP ID | M | | 9.3.3.1 | | YES | ignore |
| RAN UE NGAP ID | M | | 9.3.3.2 | Allocated at the | YES | ignore |
| | | | | target NG-RAN | | |
| | | | | node. | | |
| PDU Session | | 1 | | | YES | Ignore |
| Resource Admitted | | | | | | |
| List | | | | | | |
| >PDU Session | | 1 . . . <maxno | | | — | |
| Resource Admitted | | ofPDUSes | | | | |
| Item | | sions> | | | | |
| >>PDU Session ID | M | | 9.3.1.50 | | — | |
| >>Handover Request | M | | OCTET | Containing the | — | |
| Acknowledge | | | STRING | Handover Request | | |
| Transfer | | | | Acknowledge | | |
| | | | | Transfer IE | | |
| | | | | specified in | | |
| | | | | subclause | | |
| | | | | 9.3.4.11. | | |
| PDU Session | | 0 . . . 1 | | | YES | ignore |
| Resource Failed to | | | | | | |
| Setup List | | | | | | |
| >PDU Session | | 1 . . . <maxno | | | — | |
| Resource Failed to | | ofPDUSes | | | | |
| Setup Item | | sions> | | | | |
| >>PDU Session ID | M | | 9.3.1.50 | | — | |
| >>Handover | M | | OCTET | Containing the | — | |
| Resource Allocation | | | STRING | Handover | | |
| Unsuccessful | | | | Resource | | |
| Transfer | | | | Allocation | | |
| | | | | Unsuccessful | | |
| | | | | Transfer IE | | |
| | | | | specified in | | |
| | | | | subclause | | |
| | | | | 9.3.4.19. | | |
| Target to Source | M | | 9.3.1.21 | | YES | reject |
| Transparent Container | | | | | | |
| Criticality Diagnostics | O | | 9.3.1.3 | | YES | ignore |
| NPN Access | O | | 9.3.3.46 | | YES | reject |
| Information | | | | | | |
| RedCap Indication | O | | 9.3.1.228 | | YES | ignore |

| Range bound | Explanation |
|---|---|
| maxnoofPDUSessions | Maximum no. of PDU sessions |
| | allowed towards one UE. Value is 256. |

### 9.3.1.20 Source to Target Transparent Container

This IE is used to transparently pass radio related information from the handover source to the handover target through the core network; it is produced by the source RAN node and is transmitted to the target RAN node.

| | | | | |
|---|---|---|---|---|
| | | | IE type and | |
| IE/Group Name | Presence | Range | reference | Semantics description |

| | | | |
|---|---|---|---|
| Source to Target | M | OCTET STRING | This IE includes a transparent |
| Transparent Container | | | container from the source RAN |
| | | | node to the target RAN node. |
| | | | The octets of the OCTET |
| | | | STRING are encoded according |
| | | | to the specifications of the target |
| | | | system. |
| | | | Note: In the current version of |
| | | | the specification, this IE may |
| | | | carry either the Source NG-RAN |
| | | | Node to Target NG-RAN Node |
| | | | Transparent Container IE or the |
| | | | Source eNB to Target eNB |
| | | | Transparent Container IE as |
| | | | defined in TS 36.413 [16] or the |
| | | | Source RNC to Target RNC |
| | | | Transparent Container IE as |
| | | | defined in TS 25.413 [28]. |

### Quotation End

Non-terrestrial Network (NTN) is introduced in Rel-17 New Radio (NR) (e.g., [3] 3GPP TS 38.300 V17.2.0), defined as a Next Generation Radio Access Network (NG-RAN) consisting of Next Generation Node Bs (gNBs) providing non-terrestrial access to User Equipment (UE) by means of an NTN payload embarked on an airborne or space-borne NTN vehicle and an NTN Gateway. The UE may link to, camp on, and/or connect to the NTN network that involves airborne/spaceborne for transmission. The NTN may comprise various platforms, including low earth orbit (LEO) satellite, medium earth orbit (MEO) satellite, highly elliptical orbit (HEO) satellite, geostationary earth orbit (GEO) satellite, geostationary synchronous Orbit (GSO) satellite, non-geostationary synchronous orbit (NGSO) satellite, and/or high altitude platform station (HAPS). A LEO satellite could have earth-fixed beams (e.g., the beam is temporarily fixed on a location during a time period) or earth-moving beams (e.g., the beam is continuously moving along with the satellite). A LEO satellite could serve/provide earth moving cells (e.g., with earth-fixed beam) and/or (quasi-) earth fixed cells (e.g., with earth-moving beam). The NTN could offer a wide-area coverage and provide Network (NW) access in the scenario when Terrestrial Networks (TN) is unfeasible (e.g., desert, polar area, and/or on an airplane).

Enhancements to NR NTN would be introduced in 3GPP Rel-18 (e.g., [1] RP-221819). A large number of UEs would need to perform handover in a serving cell, e.g., due to large cell size, satellite movement. Based on chapter 7.3.2.1.4 in TR 38.821 (e.g., [4] 3GPP TS 38.331 V17.2.0), the total number of handovers per second will cause a significant signaling/singalling load in the network. The frequent handover may also result in signaling overhead and impact power consumption for the UE.

To reduce signaling for handover, e.g., especially for earth-moving cells, the network could perform some handover enhancements such as common handover, group handover, and/or 2-step handover. A common target cell configuration would be provided via broadcast. In NTN, the next serving cell(s) could be predicted by the network based on satellite ephemeris and negligible UE mobility in comparison to a satellite's motion. Most of the UEs in the source cell will perform handover to the same target cell and most information provided to each UE in the Handover (HO) command describing target cell configuration (e.g., serving CellConfig Common) is identical. It is assumed that common handover could comprise at least two different kinds of signaling and/or configurations: configurations that are common to all UEs to be handed over/handovered (e.g., broadcasted in System Information Block (SIB)) and configurations that are specific to a UE (e.g., provided in dedicated signaling). In common handover, group handover and/or 2-step handover, the network could provide common signaling and/or configuration to a UE, multiple UEs or a group of UE(s). In group handover and/or 2-step handover, the network could provide UE-specific (pre-)configuration of the target cell to each UE, then provide a group indication to multiple UEs. Certain target cell configurations such as Cell Radio Network Temporary Identifier (C-RNTI) or security keys could be sent in a dedicated manner to each UE. The UE may receive a dedicated configuration (e.g., specific to the UE) and/or a common configuration (e.g., common to the UEs to access the target cell, specific to the target cell) for handover. The UE may trigger a handover procedure when receiving the group indication. The UE may trigger a handover procedure when receiving both common configuration (e.g., a second configuration as below) and dedicated configuration (e.g., a first configuration as below).

The legacy handover procedure could be found in TS 38.300 (e.g., [3] 3GPP TS 38.300 V17.2.0) and TS 38.423 (e.g., [5] 3GPP TS 38.423 V17.2.0). As shown in FIG. 6 (Figure 9.2.3.1-1 of [3] 3GPP TS 38.300 V17.2.0), the source gNB would decide to perform a handover procedure for a UE and transmit a handover request (e.g., HANDOVER REQUEST) to the target gNB. The handover request (e.g., HANDOVER REQUEST) would comprise UE information. In response to receiving the handover request (e.g., HANDOVER REQUEST), the target gNB would transmit a handover request acknowledge/acknowledgement (e.g., HANDOVER REQUEST ACKNOWLEDGE) to the source gNB. The handover request acknowledge (e.g., HANDOVER REQUEST ACKNOWLEDGE) would comprise resources for handover for the UE. The handover request acknowledge (e.g., HANDOVER REQUEST ACKNOWLEDGE) would comprise a handover command (e.g., HandoverCommand). In response to receiving the handover request acknowledge (e.g., HANDOVER REQUEST ACKNOWLEDGE), the source gNB would transmit a Radio Resource Control (RRC) reconfiguration message (e.g., RRCReconfiguration) from the handover command (e.g., HandoverCommand) to the UE. In response to receiving the RRC reconfiguration message (e.g., RRCReconfiguration), the UE would trigger a handover procedure and transmit an RRC reconfiguration complete message (e.g., RRCReconfigurationComplete) to the target gNB.

Throughout the disclosure herein, the handover request (message) may be, be referred to, or comprise HANDOVER REQUEST. The handover request acknowledge (message) may be, be referred to, or comprise HANDOVER REQUEST ACKNOWLEDGE.

Based on the current specification as described above, before transmitting the RRC reconfiguration message (e.g., RRCReconfiguration) to the UE, the source gNB would perform a handover preparation for the UE to request resources from the target gNB. To trigger a handover, the source gNB needs to perform a handover preparation procedure for a UE with the target gNB. In a handover preparation, the source gNB transmits the handover request with a UE context information to the target gNB and receives the handover request acknowledge from the target gNB. The handover command, RRC reconfiguration message (e.g., RRCReconfiguration) with dedicated configuration (e.g., a UE-specific configuration), that is to be transmitted to the UE, would be provided by the target gNB in the handover request acknowledge. The target gNB generates the handover command (i.e., RRCReconfiguration with reconfigureWithSync) and transmits it to the source gNB via HANDOVER REQUEST ACKNOWLEDGE. The source gNB would forward the handover command to the UE without modification. The source gNB directly forwards RRCReconfiguration from the HandoverCommand in the HANDOVER REQUEST ACKNOWLEDGE to the UE.

However, to apply common handover, group handover, and/or 2-step handover, the source gNB may not provide the handover command (e.g., configuration for handover) as a whole. Instead, different parts of the is handover command (e.g., configuration for handover) may be provided separately to the UE. In such a case, the source gNB could not deliver the handover command (e.g., configuration for handover) by forwarding the handover command (e.g., configuration for handover) generated by the target gNB as in the current handover procedure and/or handover preparation. If the source gNB requests the dedicated part configuration of common handover via HANDOVER REQUEST, the same message may be used to request a dedicated part of a handover configuration or a legacy handover configuration. The target gNB does not know what type of handover the source gNB is requesting based on the current HANDOVER REQUEST (i.e., whether the target gNB should include common part in the HO command).

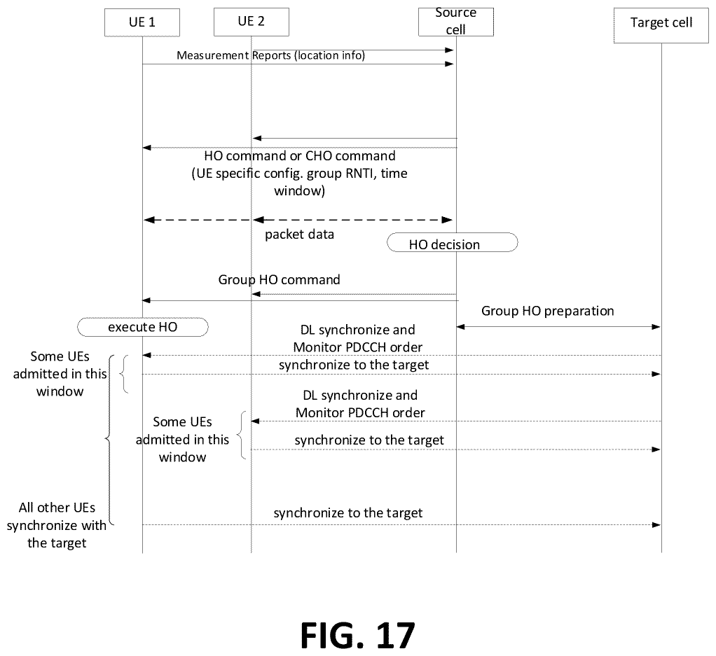

An example for common handover (and/or group handover, 2-step handover) is provided in the 3GPP RAN2 meeting. As shown in FIG. 17, the source gNB may transmit a first handover command with UE-specific configuration to a first UE and transmit a second handover command with UE-specific configuration to a second UE. Then, the source gNB may transmit a group handover command to both the first UE and the second UE. After transmitting the group handover command, the source gNB performs group handover preparation with the target gNB. However, in this case, the source gNB could not receive handover resources at the target gNB before performing the handover preparation. The source gNB could not transmit the dedicated configuration and/or common configuration to the UEs in any of the handover commands.

Throughout the disclosure herein, a UE may be one UE in a UE group. The UE may connect to an NTN cell. The UE may connect to an earth-moving cell. The UE group may be configured by the network. There may be multiple UE groups in a serving cell. There may be multiple UEs in a UE group. The UEs in the same group would be simultaneously indicated to perform handover and/or receive a common configuration (for handover).

Throughout the disclosure herein, a source gNB may be the gNB serving the UE (currently). The source gNB may serve the UE before a (group) handover procedure. The source gNB may serve a source cell. The source gNB may determine to trigger the (group) handover procedure. The source gNB may determine the UE group(s). The source gNB may provide configuration and/or information of the UE group(s), e.g., to the UE, to a target gNB. The source gNB may switch the UE to a target gNB. The target gNB may serve the UE after a handover procedure. The target gNB may serve a target cell. The UE may handover form the source cell to the target cell. The UE may handover form the source gNB to the target gNB. The source gNB and the target gNB may be different gNBs. The source gNB and the target gNB may link to the same satellite or different satellites. The source cell and the target cell may be the same cell or different cells. Throughout the disclosure herein, the handover may be or may referred to as a common handover, a group handover, a 2-step handover, and/or a handover in NTN.

Throughout the disclosure herein, the target gNB may be replaced by Access and Mobility Management Function (AMF). For example, for handover between gNBs with Xn interface (e.g., point-to-point interface between two NG-RAN nodes), the message (and/or configuration) exchange described in this disclosure may be via Xn interface between the source gNB and the target gNB. For handover between gNBs without Xn interface, the message (and/or configuration) exchange may be between the source gNB and AMF.

Throughout the disclosure herein, handover may be a change of Primary Cell (PCell) for (at least) a UE in RRC_CONNECTED. The handover may be NW triggered or Conditional Handover (CHO). The handover may be or may be referred to as a common handover, a group handover, a 2-step handover, and/or a handover in NTN.

Throughout the disclosure herein, a handover command may be an indication to trigger handover. A handover command may be (or include) (all or at least part of configuration) for handover. A handover command may be (or include) an RRC reconfiguration message (e.g., RRCReconfiguration) with ReconfigurationWithSync for PCell.

Throughout the disclosure herein, a first signaling, a second signaling, and/or a third signaling may be a signaling and/or message transmitted from the source gNB to the UE. The source gNB may transmit the first signaling in response to a first handover preparation. The source gNB may transmit a first configuration in the first signaling. The source gNB may transmit (or broadcast) the second signaling in response to the first handover preparation and/or a second handover preparation. The source gNB may transmit a second configuration in the first signaling. The source gNB may transmit (or broadcast) the third signaling in response to the first handover preparation and/or second handover preparation.

A first configuration, a second configuration, and/or a third configuration may be (or comprise) handover configuration. The first configuration and/or the second configuration may be (or comprise) a configuration used for handover (e.g., to a target cell or gNB). The first configuration, second configuration, and/or third configuration may be provided from the target gNB. The first configuration, second configuration, and/or third configuration may be provided in a handover command (e.g., HandoverCommand). The second configuration may be derived by the source gNB. The second configuration may be a part of the first configuration and/or the third configuration. The second configuration may not be a part of the first configuration. The first configuration and/or second configuration may be or comprise resources reserved at the target gNB for handover.

The first configuration may be or comprise a dedicated configuration and/or a UE-specific configuration, e.g., in the current specification (e.g., [4] 3GPP TS 38.331 V17.2.0). The first configuration may be provided to the UE via a dedicated signaling, e.g., in the current specification (e.g., [4] 3GPP TS 38.331 V17.2.0). The first configuration may be transmitted to a UE (e.g., a single UE). The first configuration may be applied to a specific UE. The first configuration may not be a cell-specific configuration. The first configuration may be a configuration specific to a group of UEs. The first configuration may not be common to a cell. The first configuration may be common to a UE group. The first configuration may be specific to a UE. The first configuration may be an RRC reconfiguration message (e.g., RRCReconfiguration) and/or a part of the RRC reconfiguration message (e.g., RRCReconfiguration) and/or a part of the RRC reconfiguration message (e.g., RRCReconfiguration). The first configuration may be or comprise a configuration in the reconfigurationWithSync except for spCellConfigCommon (or ServingCellConfigCommon) and/or NTN-Config. The first configuration may be (or comprise) one or more configurations in an RRC reconfiguration message (e.g., RRCReconfiguration) with reconfigurationWithSync (for PCell) except the second configuration. The first configuration may be (or comprise): NTN configuration (e.g., NTN-config), common serving cell configuration (e.g., for PCell, ServingCellConfigCommon, spCellConfigCommon), t304, smtc, daps-UplinkPowerConfig, sl-PathSwitchConfig, rlf-TimersAndConstants, rlmInSyncOutOfSyncThreshold, lowMobilityEvaluationConnected, goodServingCellEvaluationRLM, goodServingCellEvaluationBFD, deactivatedSCG-Config, newUE-Identity, rach-ConfigDedicated, servCellIndex, and/or spCellConfigDedicated.

The second configuration may be or comprise a common configuration and/or a group configuration. The second configuration may be or comprise a cell-specific configuration, e.g., in the current specification (e.g., [4] 3GPP TS 38.331 V17.2.0). The second configuration may be or comprise a common configuration and/or a group configuration. The second configuration may be provided to the UE via a common signaling, e.g., broadcast, multicast, system information. The second configuration may be transmitted to multiple UEs (e.g., more than one UE). The second configuration may be common to the UEs to access the target cell. The second configuration may be common to a cell. The second configuration may be applied to the UEs in the same cell. The second configuration may be or comprise a serving cell configuration (e.g., Serving CellConfigCommon) and/or an NTN configuration (e.g., NTN-Config). The second configuration may be or comprise a part of an RRC reconfiguration message (e.g., RRCReconfiguration), the serving cell configuration (e.g., ServingCellConfigCommon), an NTN configuration (e.g., NTN-Config), a Downlink (DL) configuration (e.g., DownlinkConfigCommon) and/or an Uplink (UL) configuration (e.g., UplinkConfigCommon). The second configuration may be a part of the first configuration. The second configuration may not be a part of the first configuration. The second configuration may be (or comprise) one or more configurations in RRC reconfiguration message (e.g., RRCReconfiguration) with reconfigurationWithSync (for PCell) except the first configuration. The second configuration may be (or comprise): NTN configuration (e.g., NTN-config), common serving cell configuration (e.g., for PCell, ServingCellConfigCommon, spCellConfigCommon), t304, smtc, daps-UplinkPowerConfig, sl-PathSwitchConfig, rlf-TimersAndConstants, rlmInSyncOutOfSyncThreshold, lowMobilityEvaluationConnected, goodServingCellEvaluationRLM, goodServingCellEvaluationBFD, deactivatedSCG-Config, newUE-Identity, rach-ConfigDedicated, servCellIndex, and/or spCellConfigDedicated.

The third configuration may be (or comprise) one or more configurations in an RRC reconfiguration message (e.g., RRCReconfiguration) with reconfigurationWithSync (for PCell). The third configuration may be (or comprise) all configurations in an RRC reconfiguration with reconfigurationWithSync (for PCell). The third configuration may be (or comprise) the first configuration and/or the second configuration. The third configuration may be (or comprise): NTN configuration (e.g., NTN-config), common serving cell configuration (e.g., for PCell, ServingCellConfigCommon, spCellConfigCommon), t304, smtc, daps-UplinkPowerConfig, sl-PathSwitchConfig, rif-TimersAndConstants, rlmInSyncOutOfSyncThreshold, lowMobilityEvaluationConnected, goodServingCellEvaluationRLM, goodServingCellEvaluationBFD, deactivatedSCG-Config, newUE-Identity, rach-ConfigDedicated, servCellIndex, and/or spCellConfigDedicated.

The source gNB may receive the first configuration and/or second configuration in a handover command (e.g., HandoverCommand), (part of) an RRC reconfiguration message (e.g., RRCReconfiguration) and/or a new RRC message. The handover command (e.g., HandoverCommand), (part of) an RRC reconfiguration message (e.g., RRCReconfiguration) and/or a new RRC message may be transmitted in a handover request acknowledge.

A first signaling, a second signaling, and/or a third signaling may be a signaling and/or message transmitted from the network to a UE. The network may transmit a first configuration in the first signaling. The network may transmit a second configuration in the second signaling.

The first signaling may be a dedicated signaling and/or a UE-specific signaling. The first signaling may be transmitted to a single UE. The first signaling may be an RRC message, Medium Access Control (MAC) Control Element (CE), or Downlink Control Information (DCI). The first signaling may be an RRC reconfiguration message (e.g., RRCReconfiguration) and/or a handover command. The first signaling may be and/or comprise a dedicated configuration (e.g., the first configuration), e.g., to a UE. The first signaling may be a handover configuration. The first signaling may provide resources to a UE.

The first signaling, the second signaling, and the third signaling may be different.

The second signaling may be a common signaling and/or a group signaling. The second signaling may be transmitted or broadcast to multiple UEs. The second signaling may be an RRC message, MAC CE, or DCI. The second signaling may be an RRC reconfiguration message (e.g., RRCReconfiguration), a handover command, a system information (e.g., SIB19), and/or a paging message. The second signaling may be and/or comprise a common configuration (e.g., ServingCellConfigCommon, the second configuration), e.g., to multiple UEs. The second signaling may be a (group) handover configuration and/or a (group) handover indication. The second signaling may be the third signaling. The second signaling may provide resources to (a group of) UEs for handover.

The third signaling may be a common signaling and/or a group signaling. The third signaling may be transmitted or broadcast to multiple UEs. The third signaling may be an RRC message, MAC CE, or DCI. The third signaling may be a DCI, RRC reconfiguration message (e.g., RRCReconfiguration), a handover command, a system information (e.g., SIB19), and/or a paging message. The third signaling may not comprise or may not be a handover configuration. The third signaling may be a (group) handover indication. The third signaling may be the second signaling. The third signaling may trigger a handover procedure to (a group of) UEs.

To solve the issue, the target gNB could provide different parts (e.g., more than one part) of configurations for a handover (e.g., a first configuration for a handover and a second configuration for the handover) to the source gNB separately (e.g., in different messages, in different message containers). The target gNB may provide the first configuration for a handover to the source gNB without the second configuration in a message (or message container). The target gNB may provide the second configuration for a is handover to the source gNB without the first configuration in a message (or message container).

For example, the source gNB could receive two handover configurations (e.g., a first configuration for a handover and a second configuration for the handover) from the target gNB, e.g., in a handover request acknowledge. The source gNB may transmit a handover request to the target gNB. In response to transmitting the handover request, the source gNB may receive (e.g., from the target gNB) a first configuration and a second configuration in one message or message container (e.g., HandoverCommand). In response to transmitting the handover request, the source gNB may receive (e.g., from the target gNB) a first configuration in a first message or message container (e.g., HandoverCommand) and a second configuration in a second message or message container (e.g., HandoverCommand). The message or message container(s) (e.g., HandoverCommand) may be received in a handover request acknowledge, e.g., corresponding to the handover request (e.g., HANDOVER REQUEST).

The source gNB may send the first configuration in a first signaling to a UE. The first configuration and/or the first signaling may be generated by the target gNB and forwarded by the source gNB to the UE. The source gNB may send the second configuration in a second signaling to a UE or a group of UEs. The second configuration and/or the second signaling may be generated by the target gNB and forwarded by the source gNB to the UE or the group of UEs.

The source gNB may receive (e.g., from the target gNB) the second configuration in response to transmitting a handover request for a first UE. The source gNB may not receive (e.g., from the target gNB) the second configuration in response to transmitting a handover request for a second UE and a third UE. In response to receiving the second configuration, the gNB may transmit the second configuration to the first UE, the second UE, and/or the third UE. The first UE, second UE, and third UE may be of the same UE groups. In response to receiving the second configuration, the gNB may not transmit the second configuration to a fourth UE. The fourth UE and the first UE may be of different UE groups. The first UE, second UE, and third UE may be handover to the target gNB. The first UE, second UE, and third UE may perform group handover and/or 2-step handover. The fourth UE may not be handover to the target gNB. The fourth UE may not perform group handover and/or 2-step handover.

Considering that there may be more than one kind of configuration for handover (e.g., a first configuration, a second configuration, the legacy configuration such as handover command, a configuration for group handover, a configuration for legacy handover) that can be provided to the source gNB, the target gNB may need to know which kind of configuration should be provided in response to a request from the source gNB. To this end, the source gNB may indicate to the target gNB (e.g., in a handover request) which kind of configuration for handover the target gNB should provide in response. The handover request may include an indication which indicates what kind of configuration for handover should be provided in response. The kind of configuration for handover may include: the first configuration (e.g., a part of the handover configuration to be provided to the UE via a dedicated signaling), the second configuration (e.g., a part of the handover configuration to be provided to the UE via a common signaling), the legacy handover configuration (e.g., a handover command including common and dedicated parts of handover configuration).

The source gNB may indicate the target gNB to provide the second configuration by the handover request. The source gNB may provide an indication in the handover request. The indication may be a parameter and/or Boolean. The indication may be UE information and/or (target) cell information. The source gNB may provide UE information to request the first configuration. The source gNB may provide (target) cell information to request the second configuration.

To solve the issue, a handover command or a handover configuration (e.g., the first configuration and/or the first signaling, the second configuration, and/or the second signaling) is to be sent to a UE could be generated by the source gNB (instead of generated by the target gNB and forwarded by the source gNB to the UE). For example, the source gNB could receive a first configuration from a handover request acknowledge and derive a handover configuration (to be sent to a UE) from the first configuration. The source gNB may transmit a handover request to the target gNB. In response to transmitting the handover request, the source gNB may receive (e.g., from the target gNB) a first configuration in a message or message container (e.g., HandoverCommand). The message(s) or message container(s) (e.g., HandoverCommand) may be received in a handover request acknowledge, e.g., corresponding to the handover request. The source gNB may not (directly) forward the received first configuration to the UE.

In response to receiving the first configuration, the source gNB may derive the second configuration from the first configuration for a UE or a UE group. The source gNB may send the first configuration without the second configuration (e.g., the content of the second configuration is omitted in the first configuration) in a first signaling to a UE. The source gNB may send the second configuration in a second signaling to a UE or a group of UEs.

In response to receiving the first configuration, the source gNB may divide the first configuration into the first signaling and second signaling for a UE or a UE group. The source gNB may send the first configuration without the second configuration (e.g., the content of the second configuration is omitted in the first configuration) in a first signaling to a UE. The source gNB may send the second configuration in a second signaling to a UE or a group of UEs.

In response to receiving the first configuration, the source gNB may configure and/or generate the first signaling and second signaling for a UE or a UE group. The source gNB may send the first configuration without the second configuration (e.g., the content of the second configuration is omitted in the first configuration) in a first signaling to a UE. The source gNB may send the second configuration in a second signaling to a UE or a group of UEs.

The source gNB may receive the first configuration with content of the second configuration in response to transmitting a handover request for a first UE. The source gNB may receive the first configuration without content of the second configuration in response to transmitting a handover request for a second UE and a third UE. In response to receiving the second configuration, the gNB may transmit the second configuration to the first UE, the second UE, and/or the third UE. The first UE, second UE, and third UE may be of the same UE groups. In response to receiving the second configuration, the gNB may not transmit the second configuration to a fourth UE. The fourth UE and the first UE may be of different UE groups. The first is UE, second UE, and third UE may be handover to the target gNB. The first UE, second UE, and third UE may perform group handover and/or 2-step handover. The fourth UE may not be handover to the target gNB. The fourth UE may not perform group handover and/or 2-step handover.

The source gNB may indicate the target gNB whether to provide the content of the second configuration (in the first configuration) by the handover request. The source gNB may provide an indication in the handover request. The indication may be a parameter and/or Boolean. The indication may be UE information and/or (target) cell information. The source gNB may provide (target) cell information to request (the content of) the second configuration.

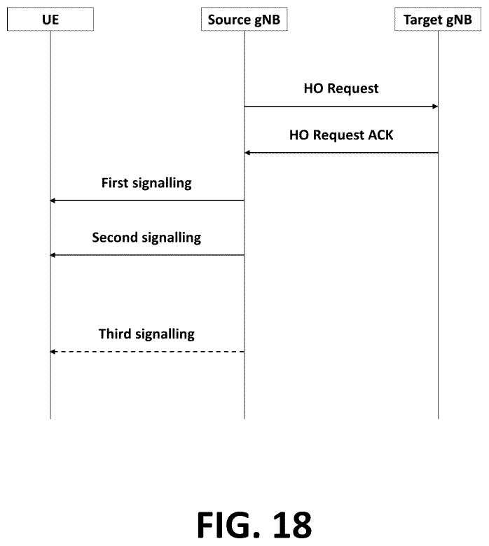

FIG. 18 provides an example for the above concepts.

To solve the issue, the source gNB could perform (at least) two handover preparations (e.g., the first handover preparation and the second handover preparation) for a handover, e.g., common handover, group handover, and/or 2-step handover. The source gNB could perform two handover preparations (e.g., the first handover preparation and the second handover preparation) for (at least) a UE, e.g., in a UE group. The (two) handover preparations are associated with the same (target) cell Identity (ID). The two handover preparations may be or may not be in parallel. The two handover preparations may be or may not be associated with the same (source) UE ID. The two handover preparations may be performed to handover a group of UEs. The two handover preparations may be performed to provide common resources and/or configurations for a group of UEs. The source gNB may receive (e.g., from the target gNB) the first configuration in the first handover preparation. The source gNB may receive the second configuration in the second handover preparation.

The source gNB may transmit a first handover request to the target gNB in a first handover preparation. In response to receiving the first handover request, the target gNB may transmit a first handover request acknowledge comprising the first configuration to the source gNB. In response to receiving the first handover request acknowledge, the source gNB may transmit a first signaling with the first configuration to a UE. The first signaling may be generated by the target gNB. The first signaling may be forwarded by the source gNB to the UE. After transmitting the first signaling, the source gNB may transmit a second handover request to the target gNB in a second handover preparation. In response to receiving the second handover request, the target gNB may transmit a second handover request acknowledge comprising the second configuration to the source gNB. In response to receiving the second handover request acknowledge, the source gNB may transmit a second signaling with the second configuration to a group of UEs. The second signaling may be generated by the target gNB. The second signaling may be forwarded by the source gNB to the UE or the group of UEs. After transmitting the second signaling, the source gNB may transmit a third signaling to the group of UEs.

The source gNB may transmit a second handover request to the target gNB in a second handover preparation. In response to receiving the second handover request, the target gNB may transmit a second handover request acknowledge comprising the second configuration to the source gNB. In response to receiving the second handover request acknowledge, the source gNB may transmit a second signaling with the second configuration to a group of UEs. The second signaling may be generated by the target gNB. The is second signaling may be forwarded by the source gNB to the UE or the group of UEs. After transmitting the second signaling, the source gNB may transmit a first handover request to the target gNB in a first handover preparation. In response to receiving the first handover request, the target gNB may transmit a first handover request acknowledge comprising a first configuration to the source gNB. In response to receiving the first handover request acknowledge, the source gNB may transmit a first signaling with the first configuration to a UE. The first signaling may be generated by the target gNB. The first signaling may be forwarded by the source gNB to the UE. After transmitting the first signaling, the source gNB may transmit a third signaling to the group of UEs.

The source gNB may perform the first handover preparation for each UE in a UE group. The source gNB may perform the second handover preparation for a UE group. In a group handover procedure, the source gNB may perform one first handover preparation and multiple second handover preparations. The source gNB may perform the first handover preparation for a first UE. The source gNB may not perform the first handover preparation for a second UE and a third UE. In response to receiving the second configuration, the gNB may transmit the second configuration to the first UE, the second UE and/or the third UE. The first UE, second UE and third UE may be of the same UE groups. In response to receiving the second configuration, the gNB may not transmit the second configuration to a fourth UE. The fourth UE and the first UE may be of different UE groups. The first UE, second UE and third UE may be handover to the target gNB. The first UE, second UE and third UE may perform group handover and/or 2-step handover. The fourth UE may not be handover to the target gNB. The fourth UE may not perform group handover and/or 2-step handover.

The source gNB may not transmit a handover request in a handover preparation (e.g., a second handover preparation). A handover request may be omitted or skipped in a handover preparation (e.g., a second handover preparation). The source gNB may receive a handover request acknowledge and/or a message comprising a second configuration without transmitting a handover request. The source gNB may receive a second configuration without transmitting a handover request. The target gNB may provide a second configuration without receiving a handover request. The source gNB may receive the second configuration before or after performing a first handover preparation. The source gNB may receive the second configuration without performing a handover preparation. The source gNB may receive common resources for a target cell (e.g., the second configuration) without providing UE information. The target gNB may provide common resources for a target cell (e.g., the second configuration, for group handover) without acquiring and/or receiving UE information. In response to receiving the second configuration, the source gNB may broadcast or transmit the second signaling to a group of UEs.

The target gNB may transmit the second configuration and/or a message comprising the second configuration if (or based on) one or more of the following conditions are met:
A first HO preparation has been performed;
The second configuration is available or updated;
A UE group has been configured;
The target cell is an NTN cell or an earth-moving cell;
The source cell is an NTN cell or an earth-moving cell;
The target gNB has not provided the second configuration for a target cell;
The target gNB has transmitted a first configuration for a UE of a UE group; and/or
The target gNB has received an indication (e.g., in a handover request) of group/common handover from the source gNB.

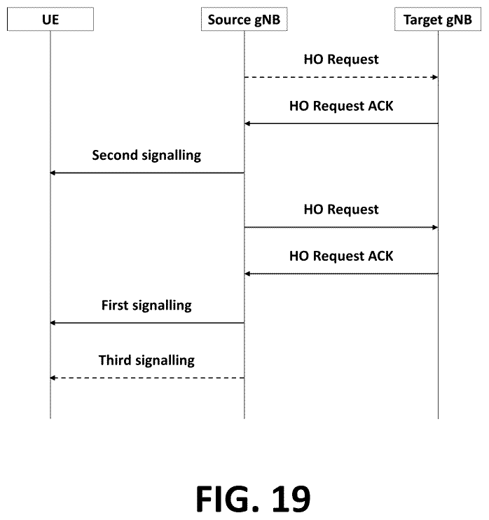

FIG. 19 provides an example for the above concepts.

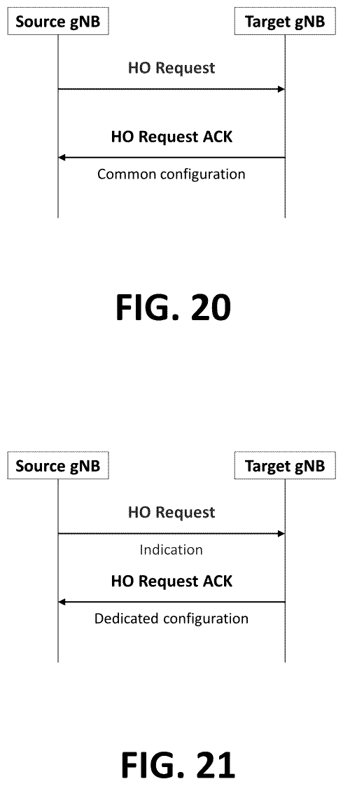

An example is shown in FIG. 20. The source gNB requests a common part of the handover configuration (e.g., a second configuration) without UE context information (or with multiple UE context information). The target gNB provides a common handover configuration (e.g., the second configuration) without receiving a UE context information (or in response to receiving multiple UE context information). The source gNB transmits a request signal without UE context information (or with multiple UE context information). The request signal may be a new version of a handover request. In response to receiving the request signal, the target gNB provides a common configuration (e.g., the second configuration) for a target cell to the source gNB. Then the source gNB broadcasts the common configuration (e.g., the second configuration) to a group of UEs.

An example is shown in FIG. 21. The source gNB provides an indication to the target gNB in a handover request to request a handover configuration (e.g., for common handover or legacy handover). The target gNB determines to provide which kind of handover configuration (e.g., a first configuration without a second configuration or a third configuration) to the source gNB based on an indication. The source gNB provides an indication to indicate the target gNB of what type of HO command (e.g., for common handover or legacy handover) is requested, via a handover request. In response to receiving the handover request, the target gNB determines which handover configuration (e.g., second configuration without first configuration, third configuration) to provide based on the indication in the handover request. For example, the target gNB provides a handover command without the common part to the source gNB based on an indication in the handover request. Then the source gNB forwards the handover command to the UE.

To solve the issue, the target gNB could determine the content, information, resources, and/or configuration in a handover request acknowledge in response to receiving a handover request. The target gNB may provide the first configuration (e.g., without/omitting the content of the second configuration) based on an indication and/or information in the handover request. The target gNB may provide the second configuration based on an indication in the handover request. The target gNB may always provide the first configuration and second configuration. The target gNB may always provide the first configuration with the content of the second configuration.

The target gNB may determine whether the handover preparation is for the first handover preparation or the second handover preparation based on an indication in the handover request.

The target gNB may determine whether the handover is a common handover or a legacy handover is based on an indication in the handover request.

The target gNB may determine to provide a second configuration in a message to the source gNB based on an indication from the source gNB. The second configuration may be or may not be transmitted in the handover request acknowledge. The indication may be or may not be transmitted in the handover request. The indication may be a parameter and/or Boolean. The indication may be UE information and/or (target) cell information.

In one or more examples, a first gNB is a source gNB, a second gNB is a target gNB, a first configuration is a UE-specific configuration, a second configuration is a common configuration for a target cell, and/or a second configuration is serving CellConfigCommon. In one or more examples, one or more UEs in a first cell handovers to a second cell. The first cell is served by the first gNB. The second cell is served by the second gNB.

In one example, a first gNB receives a second configuration from a second gNB. In response to receiving the second configuration, the first gNB broadcasts the second configuration via a system information to multiple UEs in a first cell. The first gNB decides to handover at least a UE of the multiple UEs. The first gNB decides to trigger common handover for at least the UE of the multiple UEs. The first gNB transmits a handover request to the second gNB, wherein the handover request indicates to skip the second configuration in a handover command. The handover request requests a handover command including a first configuration without the second configuration. The handover request requests a handover command omitting the second configuration. The handover request includes an indication. The indication and/or handover request indicates a common handover. The indication and/or handover request indicates skipping of the second configuration. The indication and/or handover request indicates request of a first configuration. In response to transmitting the handover request, the first gNB receives the handover command in a handover request acknowledge from the second gNB, wherein the handover command includes a first configuration without the second configuration. In response to receiving the handover command, the first gNB transmits the handover command to the UE of the multiple UEs.

In one example, a first gNB broadcasts a second configuration via a system information to multiple UEs in a first cell. The first gNB decides to handover at least a UE of the multiple UEs. The first gNB decides to trigger common handover for at least the UE of the multiple UEs. The first gNB transmits a handover request to the second gNB, wherein the handover request indicates to skip the second configuration in a handover command. The handover request requests a handover command including a first configuration without the second configuration. The handover request requests a handover command omitting the second configuration. The handover request includes an indication. The indication and/or handover request indicates a common handover. The indication and/or handover request indicates skipping of the second configuration. The indication and/or handover request indicates request of a first configuration. In response to transmitting the handover request, the first gNB receives the handover command in a handover request acknowledge from the second gNB, wherein the handover command includes a first configuration without the second configuration. In response to receiving the handover command, the first gNB transmits the handover command to the UE of the multiple UEs.

In one example, a first gNB receives a second configuration from a second gNB. In response to receiving the second configuration, the first gNB broadcasts the second configuration via a system information to multiple UEs in a first cell. The first gNB decides to handover at least a UE of the multiple UEs. The first gNB decides to trigger legacy handover for at least the UE of the multiple UEs. The first gNB transmits a handover request to the second gNB, wherein the handover request does not indicate to skip the second configuration in a handover command. The handover request requests a legacy handover command including a first configuration and the second configuration. The handover request requests a whole or legacy handover command, e.g., not omitting the second configuration. The handover request does not include an indication for common handover and/or skipping of the second configuration. In response to transmitting the handover request, the first gNB receives the handover command in a handover request acknowledge from the second gNB, wherein the handover command includes a first configuration with the second configuration. In response to receiving the handover command, the first gNB transmits the handover command to the UE of the multiple UEs.

In one example, a first gNB transmits a request signal, to the second gNB, to request a second configuration. The request signal includes no UE context information. In response to transmitting the request signal, the first gNB receives the second configuration in a response signal. In response to receiving the second configuration, the first gNB broadcasts the second configuration via a system information to multiple UEs in a first cell. The first gNB decides to handover at least a UE of the multiple UEs. The first gNB transmits a handover request to the second gNB, wherein the handover request indicates to skip the second configuration in a handover command. The handover request requests a handover command including a first configuration without the second configuration. The handover request requests a handover command omitting the second configuration. The handover request includes an indication. The indication and/or handover request indicates a common handover. The indication and/or handover request indicates skipping of the second configuration. The indication and/or handover request indicates request of a first configuration. In response to transmitting the handover request, the first gNB receives the handover command in a handover request acknowledge from the second gNB, wherein the handover command includes a first configuration without the second configuration. In response to receiving the handover command, the first gNB transmits the handover command to the UE of the multiple UEs. The request signal is another handover request. The response signal is another handover request acknowledge.

In one example, a first gNB decides to handover one or more of the multiple UEs. The first gNB transmits a request signal, to the second gNB, to request a second configuration, wherein the request signal includes multiple UE context information. In response to transmitting the request signal, the first gNB receives the second configuration in a response signal. In response to receiving the second configuration, the first gNB broadcasts the second configuration via a system information to multiple UEs in a first cell. After receiving the response signal, the first gNB receives (at least) a handover command in (at least) a handover request acknowledge from the second gNB, wherein the handover command includes a first configuration without the second configuration. In response to receiving the handover command, the first gNB transmits the handover is command to a UE of the multiple UEs. The request signal is a handover request. The response signal is another handover request acknowledge.

In one example, a second gNB transmits a second configuration to a first gNB. The second gNB receives a handover request from the first gNB, wherein the handover request indicates to skip the second configuration in a handover command. The handover request requests a handover command including a first configuration without the second configuration. The handover request requests a handover command omitting the second configuration. The handover request includes an indication. The indication and/or handover request indicates a common handover. The indication and/or handover request indicates skipping of the second configuration. The indication and/or handover request indicates request of a first configuration. In response to receiving the handover request, the second gNB determines whether to provide the second configuration in the handover command. In response to receiving the handover request, the second gNB determines to provide which handover configuration in the handover command, e.g., based on the indication. In response to receiving the handover request, the second gNB determines the type of handover or handover command, e.g., based on the indication. In response to receiving the handover request, the second gNB transmits the handover command in a handover request acknowledge to the first gNB, wherein the handover command includes a first configuration without the second configuration.

In one example, a second gNB receives a request signal, from the first gNB, to request a second configuration. The request signal includes no UE context information. In response to receiving the request signal including no UE context information, the second gNB determines to provide a second configuration to the first gNB. In response to receiving the request signal, the second gNB transmits the second configuration in a response signal. The second gNB receives a handover request from the first gNB, wherein the handover request indicates to skip the second configuration in a handover command. The handover request requests a handover command including a first configuration without the second configuration. The handover request requests a handover command omitting the second configuration. The handover request includes an indication. The indication and/or handover request indicates a common handover. The indication and/or handover request indicates skipping of the second configuration. The indication and/or handover request indicates request of a first configuration. In response to receiving the handover request, the second gNB determines to provide a first configuration without the second configuration in the handover command, e.g., based on the indication. In response to receiving the handover request, the second gNB determines the handover is for common handover, e.g., based on the indication. In response to receiving the handover request, the second gNB transmits the handover command in a handover request acknowledge to the first gNB, wherein the handover command includes a first configuration without the second configuration. The request signal is another handover request. The response signal is another handover request acknowledge.

In one example, a second gNB receives a request signal, from the first gNB, to request a second configuration and/or request handover. The request signal includes multiple UE context information. In response to receiving the request signal including multiple UE context information, the second gNB determines that the handover is a common handover, e.g., based on the indication. The second gNB provide a second configuration to the first gNB. Then the second gNB transmits a handover command in a handover request acknowledge to the first gNB, wherein the handover command includes a first configuration without the second configuration. The request signal is another handover request. The response signal is another handover request acknowledge.

In one example, a UE receives a system information from a first gNB in a first cell, wherein the system information includes a second configuration. The UE receives a handover command from the first gNB in the first cell, wherein the handover command includes a first configuration. In response to receiving the handover command, the UE performs a handover procedure to a second cell based on both the first configuration and the second configuration.

Throughout the disclosure herein, the handover request may indicate/request the handover types (e.g., common handover, handover enhancements, UE-specific handover, legacy handover) and/or the configuration types (e.g., first configuration, second configuration, third configuration, first configuration without second configuration, second configuration without first configuration).

One or more of the above and herein embodiments, concepts, methods, and/or examples could be combined, in whole or in part, with one or more of other embodiments, concepts, methods, and/or examples, or implemented individually.

Throughout the disclosure herein, one, some, and/or all instances of “signaling” may correspond to, may be supplemented with, and/or may be replaced by “message” or like terminology.

The UE may be in a cell of NTN and/or Narrowband (NB-)Internet of Things (IoT) NTN. The UE may be connected to a cell of NTN and/or (NB-)IoT NTN. The UE may be connected to a LEO, GEO, MEO, HEO, and/or HAPS. Throughout the disclosure herein, a cell may be, and/or may refer to an NTN cell.

The UE may be referred to the UE or an RRC entity of the UE.

The UE may be an NR device. The UE may be an NR-light device. The UE may be a Long Term Evolution (LTE) device. The UE may be a reduced capability device. The UE may be a mobile phone. The UE may be a wearable device. The UE may be a sensor. The UE may be a stationary device.

The NW may be a network node. The NW may be a base station. The NW may be an access point. The NW may be or comprise an Evolved Node B (eNB). The NW may be or comprise a gNB. The NW may be a gateway. The NW may be an NG-RAN node. Throughout the disclosure herein, the gNB may be replaced by the eNB. The gNB may be or may be referred to as an NR-RAN.

Providing the common cell-specific part of the handover configuration in a common signaling could reduce the signaling overhead for handover. It is especially beneficial for the case that a group of UEs handover together, e.g., feeder link switch between LEO moving cells. As for the dedicated part of the handover configuration that is UE-specific, since different UEs may have been configured with different values, the configuration may still need to be provided to the UE using a dedicated signaling. However, cell-specific part of the handover configuration may be limited, and the reduced overhead may be marginal. To further reduce the signaling overhead for handover, more enhancement should be considered.

To solve the issue, at least a UE-specific configuration for handover (e.g., a first configuration) could be included in a common signaling (for handover) (e.g., a second signaling) and/or absent (or omitted) in a dedicated signaling (for handover) (e.g., a first signaling). The UE may apply the UE-specific configuration for handover in the common signaling (for handover). The UE-specific configuration for handover may be optional in the common signaling (for handover). The UE-specific configuration for handover may be mandatory in the common signaling (for handover). The dedicated signaling (for handover) may not trigger a handover. The UE may not trigger a handover upon (or in response to) receiving the dedicated signaling (for handover). The UE may perform a handover based on the common signaling (for handover) and the dedicated signaling (for handover). The UE may trigger a handover upon (or in response to) receiving the common signaling (for handover). The UE may trigger a handover upon (or in response to) receiving a handover indication after receiving the common signaling (for handover) and the dedicated signaling (for handover). The UE-specific configuration (e.g., a first configuration) may be used for common handover, 2-step handover, and/or group handover. The common signaling, the dedicated signaling, and/or the handover indication may be used for common handover, 2-step handover, and/or group handover.

The UE-specific configuration for handover (e.g., a first configuration) may be allowed to be included in a dedicated signaling for handover (e.g., a first signaling). The UE-specific configuration for handover may be optional in the dedicated signaling for handover. The UE may consider the UE-specific configuration in the common signaling (e.g., for handover) as a default value, e.g., shared by a group of UEs. The UE may apply the UE-specific configuration in the common signaling (for a handover) if the UE-specific configuration is not included in a dedicated signaling (for the handover) (e.g., a first signaling). The UE may not apply the UE-specific configuration in the common signaling (for a handover) if the UE-specific configuration is included in a dedicated signaling (for the handover) (e.g., a first signaling). The UE may apply the UE-specific configuration in the dedicated signaling (for the handover) (e.g., a first signaling) if the UE-specific configuration is included in the dedicated signaling (for the handover) (e.g., a first signaling). The UE may determine whether to apply the UE-specific configuration in the common signaling (for a handover) based on whether the UE-specific configuration is included in a dedicated signaling (for the handover) (e.g., a first signaling).

The UE-specific configuration for handover (e.g., a first configuration) may not be allowed to be included in a dedicated signaling for handover (e.g., a first signaling). The UE-specific configuration for handover may be absent (or omitted) in a dedicated signaling for handover (e.g., a first signaling).

At least a configuration for handover that is not cell-specific (e.g., a first configuration) could be included in a common signaling (e.g., for handover) (e.g., a second signaling). The configuration for handover may be specific to a group of UEs. The group of UEs may be the UEs which can receive the common signaling. The configuration may be common for the group of UEs. The configuration may be different for different groups of UEs.

The UE-specific configuration (e.g., a first configuration) may be a configuration that is included in a dedicated signaling triggering a handover (e.g., RRC reconfiguration message including reconfigurationWithSync for PCell or Master Cell Group (MCG)). The UE-specific configuration (e.g., a first configuration) may not be (allowed to be) included in system information. For a (UE-specific) handover and/or NW-triggered handover, the UE-specific configuration is provided by the dedicated signaling trigger the handover (e.g., RRC reconfiguration message including reconfigurationWithSync for PCell or MCG). The (UE-specific) handover may be a handover where a handover command is dedicated to the UE. The NW-triggered handover may be a handover triggered by a handover command (e.g., RRC reconfiguration message including reconfigurationWithSync for PCell or MCG).

The UE-specific configuration (e.g., a first configuration) may be (or include) one or more of the following:
T304
A value configured for timer T304. The timer or the configuration may be used to determine handover failure. The UE may consider handover failure upon (or in response to) the timer T304 expiry.
smtc
The measurement timing configuration (e.g., configured as SSB-MTC), e.g., timing occasions at which the UE measures Synchronization Signal Blocks (SSBs). The SSB periodicity/offset/duration configuration of target cell for NR Primary Secondary Cell (PSCell) change and NR PCell change. The network sets the periodicityAndOffset to indicate the same periodicity as ssb-periodicityServingCell in spCellConfigCommon or sets to the same periodicity as ssb-Periodicity-r17 in nonCellDefiningSSB-r17 if the first active DL Bandwidth Part (BWP) included in this RRC message is configured with nonCellDefiningSSB-r17 for Reduced Capability (RedCap).
For the case of NR PCell change, the smtc is based on the timing reference of (source) PCell. For case of NR PSCell change, it is based on the timing reference of source PSCell.
daps-UplinkPowerConfig
The power related configuration for Dual Active Protocol Stack (DAPS) handover. The configuration may be (or comprise) the maximum total transmit power to be used by the UE in the source cell group during DAPS handover (e.g., p-DAPS-Source), the maximum total transmit power to be used by the UE in the target cell group during DAPS handover (e.g., p-SAPS-Target), the uplink power sharing mode that the UE uses in DAPS handover (e.g., uplinkPowerSharingDAPS-Mode).
sl-PathSwitchConfig
The configuration for sidelink path switch. The configuration may be (or comprise) the Layer 2 (L2) source Identify (ID) of the target L2 UE-to-Network (U2N) Relay UE during path switch (e.g., targetRelayUE-Identity), the timer value of T420 to be used during path switch (e.g., T420).
rlf-TimersAndConstants
The timers and constants for detecting and triggering cell-level radio link failure. The configuration may be (or comprise) T310 (e.g., a timer that the UE considers Radio Link Failure (RLF) upon expiry), N310 (e.g., maximum number of consecutive “out-of-sync” indications for the Special Cell (SpCell) received from lower layers), N311 (e.g., maximum number of consecutive “in-sync” indications for the SpCell received from lower layers), T311 (e.g., a timer to control the duration of RRC connection re-establishment procedure).
rlmInSyncOutOfSyncThreshold
The Block Error Rate (BLER) threshold pair index for In Service (IS)/Out of Service (OOS) indication generation. n1 corresponds to the value 1. When the field is absent, the UE applies the value 0. Whenever this is reconfigured, UE resets N310 and N311, and stops T310, if running. Network does not include this field.
lowMobilityEvaluationConnected
The configuration indicates the criterion for a UE to detect low mobility in RRC_CONNECTED in an SpCell. The s-SearchDeltaP-Connected is the parameter “S_{SearchDeltaP-connected}”. Value dB3 corresponds to 3 dB, dB6 corresponds to 6 dB and so on. The t-SearchDeltaP-Connected is the parameter “T_{SearchDeltaP-Connected}”. Value s5 means 5 seconds, value s10 means 10 seconds and so on. Low mobility criterion is configured in NR PCell for the case of NR Standalone (SA)/NR Carrier Aggregation (CA)/NR-E-ULTRA Dual Connectivity (NE-DC)/NR-DC, and in the NR PSCell for the case of E-ULTRA Dual Connectivity (EN-DC).
goodServingCellEvaluationRLM
The configuration indicates the criterion for a UE to detect the good serving cell quality for Radio Link Monitoring (RLM) relaxation in the SpCell in RRC_CONNECTED. The field is always configured when the network enables RLM relaxation for the UE in this SpCell.
goodServingCellEvaluationBFD The configuration indicates the criterion for a UE to detect the good serving cell quality for Beam Failure Detection (BFD) relaxation in the SpCell in RRC_CONNECTED. The field is always configured when the network enables BFD relaxation for the UE in this SpCell.
deactivatedSCG-Config
The configuration applicable when the Secondary Cell Group (SCG) is deactivated. The network always configures this field before or when indicating that the SCG is deactivated in an RRCReconfiguration, RRCResume, Evolved Universal Terrestrial Radio Access (E-UTRA) RRCConnectionReconfiguration or E-UTRA RRCConnectionResume message.
newUE-Identity
An RNTI value. The configuration may be C-RNTI of the UE to be used in the target cell.
rach-ConfigDedicated
The random access configuration that is UE-specific (or not cell-specific). The Random Access (RA) configuration to be used for the reconfiguration with sync (e.g., handover). The UE performs the RA according to these parameters in the firstActiveUplinkBWP. The configuration may be (or include) contention-free random access related configuration(s).
servCellIndex
The configuration may be a serving cell index of the target PCell.
spCellConfigDedicated
The dedicated configuration of the target PCell.

For at least some of the above and herein configuration(s), the configuration(s) may be included in a common signaling (for handover) (e.g., the second signaling). The configuration(s) may not be (allowed to be) included in a dedicated signaling (for handover) (e.g., the first signaling). The UE may apply the configuration(s) in the common signaling (for handover) (e.g., regardless of whether the configuration(s) is included in the dedicated signaling (for handover)). The configuration(s) may be (or include): T304, smtc, daps-UplinkPowerConfig, and/or sl-PathSwitchConfig.

For at least some of the above and herein configuration(s), the configuration(s) may be included in a common signaling (for handover) (e.g., the second signaling). The configuration(s) may be (allowed to be) included in a dedicated signaling (for handover) (e.g., the first signaling). The UE may apply the configuration(s) in the common signaling (for handover) based on whether the configuration(s) is included in the dedicated signaling (for handover). The UE may apply the configuration(s) in the common signaling (for handover) if the configuration(s) is not included in the dedicated signaling (for handover). The UE may not apply the configuration(s) in the common signaling (for handover) if the configuration(s) is included in the dedicated signaling (for handover). The configuration(s) may be (or include): Rlf-TimersAndConstants, rlmInSyncOutOfSyncThreshold, lowMobilityEvaluationConnected, goodServingCellEvaluationRLM, goodServingCellEvaluationBFD, and/or deactivatedSCG-Config.

For at least some of the above and herein configuration(s), the configuration(s) may not be (allowed to be) included in a common signaling (for handover) (e.g., the second signaling). The configuration(s) may be included in the dedicated signaling (for handover). The configuration(s) may be (or include): newUE-Identity, Random Access Channel (RACH)-ConfigDedicated, servCellIndex, and/or spCellConfigDedicated.

The target gNB may determine the content, information, resources, and/or configuration in a handover request acknowledge (e.g., HANDOVER REQUEST ACKNOWLEDGE) in response to receiving a handover request (e.g., HANDOVER REQUEST). The target gNB may provide the first configuration (e.g., without/omitting the content of the second configuration) based on an indication and/or information in the handover request (e.g., HANDOVER REQUEST). The target gNB may provide the second configuration based on an indication in the handover request (e.g., HANDOVER REQUEST). The target gNB may always provide the first configuration and second configuration. The target gNB may always provide the first configuration with the content of the second configuration.

The target gNB may determine whether the handover preparation is for the first handover preparation or the second handover preparation based on an indication in the handover request (e.g., HANDOVER REQUEST).

The target gNB may determine to provide a second configuration in a message to the source gNB based on an indication from the source gNB. The second configuration may be or may not be transmitted in the handover request acknowledge (e.g., HANDOVER REQUEST ACKNOWLEDGE). The indication may be or may not be transmitted in the handover request (e.g., HANDOVER REQUEST). The indication may be a parameter and/or Boolean. The indication may be UE information and/or (target) cell information.

A handover procedure enables a UE in RRC_CONNECTED to change its serving cell (e.g., PCell) from a source cell to a target cell. The source cell may be controlled by a source gNB and the target cell may be controlled by a target gNB. The legacy (or conventional, UE-specific) handover procedure could be as shown in FIG. 6 (Figure 9.2.3.1-1 of [3] 3GPP TS 38.300 V17.2.0). When (or in response to) the source gNB decides to perform a handover procedure for a UE, the source gNB transmits a handover request to the target gNB, e.g., for preparing handover. The handover request may comprise UE information (e.g., UE ID, UE context information). In response to receiving the handover request, the target gNB transmits a handover request acknowledge to the source gNB. The handover request acknowledge could comprise the configuration (and/or resources) for the handover. The handover request acknowledge could comprise the message (e.g., RRC reconfiguration) for handover to be transmitted to the UE (e.g., a handover command, HandoverCommand). The message may be used to trigger a handover for the UE. In response to receiving the handover request acknowledge, the source gNB could transmit an RRC reconfiguration message (e.g., RRCReconfiguration) from the handover command (e.g., HandoverCommand) to the UE. In response to receiving the RRC reconfiguration message (e.g., RRCReconfiguration), the UE may trigger a handover procedure, and/or transmit an RRC reconfiguration complete message (e.g., RR CReconfigurationComplete) to the target gNB.

The message exchange (e.g., handover request, handover request acknowledge, defined in [5] 3GPP TS 38.423 V17.2.0) between a source gNB and a target gNB (directly) requires Xn interface between the source gNB and the target gNB. For handover between a source gNB and a target gNB without Xn interface, the signaling for handover preparation may need to be exchanged via Core Network (CN) (e.g., AMF). For example, when (or in response to) the source gNB decides to perform a handover procedure for a UE, the source gNB performs a handover preparation procedure to the AMF by transmitting a handover required (e.g., HANDOVER REQUIRED (e.g., [7] 3GPP TS 38.413 V17.2.0) message as a request and receiving a handover command (e.g., HANDOVER COMMAND of [7] 3GPP TS 38.413 V17.2.0) message in response. The AMF may perform a handover resource allocation procedure (e.g., in response to receiving the handover required message) to the target gNB by transmitting a handover request (e.g., HANDOVER REQUEST of [7] 3GPP TS 38.413 V17.2.0) and receiving a handover request acknowledge (e.g., HANDOVER REQUEST ACKNOWLEDGE of [7] 3GPP TS 38.413 V17.2.0) in response. The AMF may transmit the handover command to the source gNB (e.g., after receiving the handover request acknowledge message) based on the handover request acknowledge message from the target gNB. The source gNB may transmit an RRC reconfiguration message (e.g., RRCReconfiguration) for handover (e.g., with ReconfigurationWithSync for PCell) to the UE based on the handover command message received from the AMF. In response to receiving the RRC reconfiguration message (e.g., RRCReconfiguration), the UE may trigger a handover procedure, and/or transmit an RRC reconfiguration complete message (e.g., RRCReconfigurationComplete) to the target gNB.

For the handover enhancements (e.g., common handover, group handover, and/or 2-step handover), various enhancements could be applied to the current handover procedure. A legacy handover may be a handover without the handover enhancements (e.g., common handover, group handover, and/or 2-step handover). A common handover may be a handover with handover enhancements. A legacy handover may be a UE-specific handover.

For example (e.g., common handover and/or group handover), the configuration for a handover, originally included in a dedicated handover command, could be separated into a common part (e.g., cell-specific configuration) and a dedicated part (e.g., UE-specific configuration). The common part of the configuration for handover could be provided (to the UE) in a common signaling (e.g., broadcast, multicast, and/or system information). The dedicated part of the configuration for handover could be provided (to the UE) in a dedicated signaling (e.g., RRC reconfiguration message). The common signaling may be transmitted to more than one UE (e.g., a group of UEs). The dedicated signaling may be transmitted to a specific UE. The network may transmit a common signaling to a first UE and a second UE. The network may transmit a first dedicated signaling to the first UE and transmit a second dedicated signaling to the second UE. The first UE and the second UE may be different UEs (e.g., in a same UE group).

For example (e.g., 2-step handover and/or group handover), the network could provide the configuration for handover (to the UE) in advance without triggering the handover. Upon receiving the configuration for handover, the UE stores the configuration for handover. The configuration for handover may be a common configuration (e.g., cell-specific configuration) and/or a dedicated configuration (e.g., UE-specific configuration). After providing the configuration for handover, the network could transmit a handover indication to trigger a handover. The UE may trigger a handover upon (or in response to) receiving the handover indication. The handover indication may be common to at least a group of UEs. The handover indication may be broadcast, multicast, and/or system information. The handover indication may be a DCI and/or MAC CE. The handover indication may comprise or not comprise (part of) a handover configuration. In such a case, the group of UEs.

To solve the issue, considering that there may be more than one set of configurations for handover (e.g., a first configuration, a second configuration, the legacy configuration such as HandoverCommand, a configuration for group handover, a configuration for legacy handover) that can be possibly provided to the source gNB (or a first network node, a network node requesting handover configuration for a UE), the target is gNB (or a second network node, a network node providing handover configuration for a UE) needs to know which or what set(s) of configurations for handover should be provided in response to a request from the source gNB (or a first network node, a network node requesting handover configuration for a UE).

The source gNB could indicate (e.g., by providing an indication to) the target gNB (e.g., in a first message, in a message for requesting handover configuration, in a message for preparing handover, in a handover request) to provide at least a specific set of configurations for handover (e.g., a first configuration, a second configuration, and/or a third configuration). The target gNB could (determine to) provide (or include) what (or which) set(s) of configurations for handover, e.g., based on the indication, upon (or in response to) receiving the first message, in a second message, in a response message of the first message, in a message providing a handover configuration, and/or in a handover request acknowledge. The specific set of configurations may be included in the response message of the first message. The specific set of configurations may be included (or encoded) in a message container. The message container may be forwarded (or relayed) by the source gNB to the UE. The message container may be extracted by the source gNB, and/or received by the UE. The specific set of configurations may be applied (or stored) by the UE for handover, e.g., upon (or in response to) receiving the message container.

Throughout the disclosure herein, the following may be interchangeable: a/the handover request, a/the first message, a/the message for requesting handover configuration, a/the message for preparing handover, a/the HANDOVER REQUEST, a/the handover required message.

Throughout the disclosure herein, the following may be interchangeable: a/the second message, a/the response message of the first message, a/the message providing a handover configuration, a/the handover request acknowledge, a/the HANDOVER REQUEST ACKNOWLEDGE, a/the handover command.

The source gNB could indicate (e.g., by providing an indication to) the AMF (e.g., in a first message, in a message for requesting handover configuration, in a message for preparing handover, in a handover required) to provide at least a specific set of configurations for handover (e.g., a first configuration, a second configuration, and/or a third configuration). The AMF could (determine to) provide (or include) what (or which) set(s) of configurations for handover, e.g., based on the indication, upon (or in response to) receiving the first message, in a second message, in a response message of the first message, in a message providing a handover configuration, and/or in a handover command. The AMF may provide the specific set of configurations based on a message received from the target gNB (e.g., a handover request acknowledge) to the source gNB. For example, the AMF may forward the specific set of configurations received from the target gNB. The specific set of configurations may be included in the response message of the first message. The specific sets of configuration may be included (or encoded) in a message container. The message container may be forwarded (or relayed) by the source gNB to the UE. The message container may be extracted by the source gNB, and/or received by the UE. The specific set of configurations may be applied (or stored) by the UE for handover, e.g., upon (or in response to) receiving the message container.

The AMF could indicate (e.g., by providing an indication to) the target gNB (e.g., in a first message, in a message for requesting handover configuration, in a message for preparing handover, in a handover request) to provide at least a specific set of configurations for handover (e.g., a first configuration, a second configuration, and/or a third configuration). The AMF may provide the indication based on a message received from the source gNB (e.g., a handover required). For example, the AMF may forward the indication received from the source gNB. The target gNB could (determine to) provide (or include) what (or which) set(s) of configurations for handover, e.g., based on the indication, upon (or in response to) receiving the first message, in a second message, in a response message of the first message, in a message providing a handover configuration, and/or in a handover request acknowledge. The specific set of configurations may be included in the response message of the first message. The specific set of configurations may be included (or encoded) in a message container. The message container may be forwarded (or relayed) by the AMF to the source gNB. The message container may be extracted by the source gNB, and/or received by the UE. The specific set of configurations may be applied (or stored) by the UE for handover, e.g., upon (or in response to) receiving the message container.

The indication may indicate (to request) a first configuration. The specific set of configurations may be (or include) a first configuration. The first configuration may be (or include) the first configuration mentioned above, a part of the handover configuration to be provided to the UE via a dedicated signaling, and/or a part of the handover configuration to be provided to the UE in one of a first step of handover (e.g., the first signaling mentioned above, the second signaling mentioned above, the third signaling mentioned above). Upon (or in response to) receiving the indication (for the first configuration), the target gNB (or AMF) may provide (or include) the first configuration in a response message (e.g., the second message). The response message (e.g., the second message) may not include another/other handover configuration (e.g., the second configuration). For example, a first value (e.g., in the first message) is used (e.g., by the source gNB or AMF) to request a first configuration (e.g., for handover). Upon (or in response to) receiving the first value, the target gNB (or AMF) includes the first configuration in a response message (e.g., the second message). The first value may be a value of cause. The first value may be a value of handover type.

The indication may indicate (to request) a second configuration. The specific set of configurations may be (or include) a second configuration. The second configuration may be (or include) the second configuration mentioned above, a part of the handover configuration to be provided to the UE via a common signaling, and/or a part of the handover configuration to be provided to the UE in one of a second step of handover (e.g., the first signaling mentioned above, the second signaling mentioned above, the third signaling mentioned above). Upon (or in response to) receiving the indication (for the second configuration), the target gNB (or AMF) may provide (or include) the second configuration in a response message (e.g., the second message). The response message (e.g., the second message) may not include another/other handover configuration (e.g., the first configuration). For example, a second value (e.g., in the first message) is used (e.g., by the source gNB or AMF) to request a second configuration (e.g., for handover). Upon (or in response to) receiving the second value, the target gNB (or AMF) includes the second configuration in a response message (e.g., the second message). The second value may be a value of cause. The second value may be a value of handover type.

The indication may indicate (to request) a third configuration. The specific set of configurations may is be (or include) a third configuration. The third configuration may be (or include) a handover command including common and dedicated parts of the handover configuration, a (full) handover configuration to be provided to the UE triggering the handover, all configurations required for handover, and/or HandoverCommand (such as what is defined in [4] 3GPP TS 38.331 V17.2.0). Upon (or in response to) receiving the indication (for the third configuration), the target gNB (or AMF) may provide (or include) the third configuration in a response message (e.g., the second message). For example, a third value (e.g., in the first message) is used (e.g., by the source gNB or AMF) to request a third configuration (e.g., for handover). Upon (or in response to) receiving the third value, the target gNB (or AMF) includes the third configuration in a response message (e.g., the second message). The third value may be a value of cause. The third value may be a value of handover type.

The indication may indicate (to request) what set(s) of configurations (among the first configuration, the second configuration, and/or the third configuration). Upon (or in response to) receiving the indication, the target gNB (or AMF) may provide (or include) the specific set(s) of configurations indicated by the indication.

The indication may indicate a type of handover (or signaling for handover). For example, the indication may indicate a common part of a handover, and/or one of a first step (e.g., in a 2-step handover or group handover). The indication may correspond to the second configuration (or the first configuration). For example, the indication may indicate a dedicated part of a handover, and/or one of a second step (e.g., in a 2-step handover or group handover). The indication may correspond to the first configuration (or the second configuration). For example, the indication may indicate a common handover, group handover, 2-step handover, and/or legacy handover.

The indication may be explicit or implicit. For example, the indication may be (indicated by) a cause value, e.g., in a request message (e.g., the first message). For example, the indication may be (indicated by) a handover type, e.g., in a request message (e.g., the first message). For example, the indication may be (indicated by) presence or absence of UE context information (or RRC context), e.g., in a request message (e.g., the first message). For example, the indication may be (indicated by) presence or absence of an (new) information element (IE) or a field, e.g., in a request message (e.g., the first message). The (new) information element or field may be or may be related to information of UE(s) and/or UE groups. The (new) information element or field may be related to handover enhancements.

To solve the issue, different (request) messages could be used to request different sets of configurations for handover (e.g., the first configuration, the second configuration, and/or the third configuration). Different (response) messages could be used to provide the (requested) different sets of configurations for handover.

A message other than handover request may be used to request a (set of) configuration for handover. The (set of) configuration for handover may be (or include) the first configuration and/or the second configuration. For example, Xn setup request message may be used to request a (set of) configuration for handover.

A message other than handover request acknowledge may be used to provide a (set of) configuration is for handover. The (set of) configuration for handover may be (or include) the first configuration and/or the second configuration. For example, a Xn setup response message, a NG-RAN node configuration update, a RAN configuration update, and/or an AMF configuration update may be used to provide a (set of) configuration for handover. The (set of) configuration for handover may be provided without a request. The (set of) configuration for handover may be provided when (or in response to) update of the (set of) configuration.

Throughout the disclosure herein, a first network node may be an NG-RAN node, a CN node, a (source) gNB, a (target) gNB, an AMF, a network node requesting handover configuration for a UE.

Throughout the disclosure herein, a second network node may be an NG-RAN node, a CN node, a (source) gNB, a (target) gNB, an AMF, a network node providing handover configuration for a UE.

The first network node (e.g., the source gNB) may use (or transmit) a first request message to the second network node (e.g., the target gNB) to request a first set of configurations for handover. Upon (or in response to, or if) receiving the first request message, the second network node (e.g., the target gNB) may provide (or include) the first set of configurations for handover in a first response message (to the first network node (e.g., the source gNB)). The first request message may not (be able to) request a second set of configurations for handover and/or a third set of configurations for handover.

The first network node (e.g., the source gNB) may use (or transmit) a second request message to the second network node (e.g., the target gNB) to request a second set of configurations for handover. Upon (or in response to, or if) receiving the second request message, the second network node (e.g., the target gNB) may provide (or include) the second set of configurations for handover in a second response message (to the first network node (e.g., the source gNB)). The second request message may not (be able to) request a first set of configurations for handover and/or a third set of configurations for handover.

The first network node (e.g., the source gNB) may use (or transmit) a third request message to the second network node (e.g., the target gNB) to request a third set of configurations for handover. Upon (or in response to, or if) receiving the third request message, the second network node (e.g., the target gNB) may provide (or include) the third set of configurations for handover in a third response message (to the first network node (e.g., the source gNB)). The third request message may not (be able to) request a first set of configurations for handover and/or a second set of configurations for handover.

The second network node (e.g., the target gNB) could (determine to) provide (or include) what (or which) set(s) of configurations for handover based on which message is received.

The first set of configurations, the second set of configurations, and/or the third set of configurations may be included (or encoded) in a message container. The message container may be forwarded (or relayed) by the first network node (e.g., the source gNB) to the UE. The message container may be extracted by the first network node (e.g., the source gNB), and/or received by the UE. The specific set of configurations may be applied (or stored) by the UE for handover, e.g., upon (or in response to) receiving the message container.

The message container may not include other set of configurations (e.g., the first set of configuration, the second set of configuration, and/or the third set of configuration).

The first request message, the second request message, and/or the third request message may be a handover request, a Xn setup request, and/or a (new) message for requesting handover configuration (e.g., group handover request).

The first response message, the second response message, and/or the third response message may be a handover request acknowledge, a Xn setup response, and/or a (new) message for providing handover configuration (e.g., group handover request acknowledge).

The first set of configurations, the second set of configurations, and/or the third set of configurations may be the first configuration, the second configuration, and/or the third configuration.

For example, a group dedicated handover request (or a group dedicated handover required) message may be used (by the first network node (e.g., the source gNB)) to request the first configuration (from the second network node (e.g., the target gNB)). The group dedicated handover request acknowledge (or a group dedicated handover command) message may be used (by the second network node (e.g., the target gNB)) to provide the first configuration (to the first network node (e.g., the source gNB)).

For example, a group common handover request (or a group common handover required) message may be used (by the first network node (e.g., the source gNB)) to request the second configuration (from the second network node (e.g., the target gNB)). The group common handover request acknowledge (or a group dedicated handover command) message may be used (by the second network node (e.g., the target gNB)) to provide the second configuration (to the first network node (e.g., the source gNB)).

For example, the handover request (or a handover required) message may be used (by the first network node (e.g., the source gNB)) to request the third configuration (from the second network node (e.g., the target gNB)). The handover request acknowledge (or a handover command) message may be used (by the second network node (e.g., the target gNB)) to provide the third configuration (to the first network node (e.g., the source gNB)).

For example, the Xn setup request message may be used (by the source gNB) to request the second configuration (from the target gNB). The Xn setup response message may be used (by the target gNB) to provide the second configuration (to the source gNB).

Based on the current Xn application protocol specification (e.g., [5] 3GPP TS 38.423 V17.2.0), the handover request message needs to include one and only one UE context information for a UE. The UE context information is used to indicate the handover is for which UE and its corresponding UE context. Based on the current NG application protocol specification (e.g., [7] 3GPP TS 38.413 V17.2.0), the handover required message (from source gNB to AMF) and/or the handover request message (from AMF to target gNB) needs to include one and only one message container for a UE. The message container may be used to (transparently) pass radio related information from the handover source to the handover target through the core network. If source gNB requests the common part configuration of common handover via a HANDOVER REQUEST, the source gNB needs to include UE context information for one UE in the HANDOVER REQUEST. However, for common handover, group handover and/or 2-step handover, the configuration for handover (to be provided from the target gNB to source gNB, via AMF or not) may not be specific to a UE (e.g., for common handover). The common part configuration of common handover is common to all UEs to be handovered. It is unclear how to include UE context information in a HANDOVER REQUEST for common handover. Moreover, the source gNB may need to prepare a lot of UEs at the same time or in a short time period (e.g., for group handover). Based on the current specification, one handover request (or handover required) message can only prepare handover for one UE, which seems inefficient.

To solve the issue, a handover request message (or a message to request handover configuration) could include multiple UE context information (for multiple UEs) or no UE context information. The handover request message (or a message to request handover configuration) could include multiple UE IDs (for multiple UEs) or no UE ID. The UE ID may be associated to the UE context information. One UE ID may be associated to one UE context information. The UE ID may be a NG-RAN node UE Xn Application Protocol (XnAP) ID. The UE ID may be used to identify a UE (e.g., over the Xn interface).

The UE context information may be (or include): UE capabilities (e.g., security capabilities), UE security information (e.g., Access Stratum (AS) security information), UE aggregate maximum bit rate, Protocol Data Unit (PDU) session resources (e.g., PDU session resources to be setup list), RRC context (e.g., HandoverPreparationInformation), and/or UE history information.

A handover required message, a handover request message, and/or a message to request handover configuration could include multiple message containers (for multiple UEs) or no message container. The handover required message, the handover request message, and/or the message to request handover configuration could include multiple UE IDs (for multiple UEs) or no UE ID. The UE ID may be associated to the message container. One UE ID may be associated to one message container. The UE ID may be an AMF UE Next-Generation Application Protocol (NGAP) ID, RAN UE NGAP ID, and/or target ID. The UE ID may be used to identify a UE or UE association (e.g., over the NG interface, within the NG-RAN node). The UE, UE ID, and/or the message container may be associated to a PDU session, PDU session ID, and/or PDU session resource.

The message container may be (or include): Source to Target Transparent Container (e.g., [7] 3GPP TS 38.413 V17.2.0), Source NG-RAN Node to Target NG-RAN Node Transparent Container (e.g., [7] 3GPP TS 38.413 V17.2.0), and/or HandoverPreparationInformation (e.g., [4] 3GPP TS 38.331 V17.2.0).

A response message to the request (e.g., a handover request acknowledge, a handover command) could include a handover configuration for multiple UEs, and/or message containers for multiple UEs.

The message container may be (or include): Target NG-RAN node To Source NG-RAN node Transparent Container (e.g., [5] 3GPP TS 38.423 V17.2.0), HandoverCommand (e.g., [4] 3GPP TS 38.331 V17.2.0), Target to Source Transparent Container (e.g., [7] 3GPP TS 38.413 V17.2.0), and/or Target NG-RAN Node to Source NG-RAN Node Transparent Container (e.g., [7] 3GPP TS 38.413 V17.2.0).

Throughout the disclosure herein, a first network node may be an NG-RAN node, a CN node, a (source) gNB, a (target) gNB, an AMF.

Throughout the disclosure herein, a second network node may be an NG-RAN node, a CN node, a (source) gNB, a (target) gNB, an AMF.

The second network node (e.g., the target gNB) may (determine to) provide (or include) what (or which) set(s) of configurations for handover based on whether the message includes one UE ID, no UE ID, or multiple UE IDs. The second network node (e.g., the target gNB) may (determine to) provide (or include) what (or which) set(s) of configurations for handover based on whether the message includes one UE context information, no UE context information, or multiple UE context information. The set(s) of configurations may be (or include) the first configuration, the second configuration, and/or the third configuration mentioned above. The second network node (e.g., the target gNB) may include the first configuration, the second configuration, and/or the third configuration in a response message of the handover request message (or a message to request handover configuration).

For example, the first network node (e.g., the source gNB) may transmit a message (e.g., a first message, a handover request message, a message for requesting handover configuration) to the second network node (e.g., the target gNB), wherein the message includes no UE ID and/or no UE context information (e.g., associated with the UE ID). The message with no UE ID (or UE context information) may be used to request a first set of configurations (e.g., the first configuration, the second configuration). Upon (or in response to, or if) receiving the message, the second network node (e.g., the target gNB) includes (or provides) the first set of configurations (e.g., the first configuration, the second configuration) in a response message (e.g., a second message, a handover request acknowledge, a message for providing handover configuration).

For example, the first network node (e.g., the source gNB) may transmit a message (e.g., a first message, a handover request message, a message for requesting handover configuration) to the second network node (e.g., the target gNB), wherein the message includes multiple UE IDs and/or multiple UE context information (e.g., corresponding to the multiple UE IDs). The message with multiple UE IDs (or UE context information) may be used to request a second set of configurations (e.g., the first configuration, the second configuration). Upon (or in response to, or if) receiving the message, the second network node (e.g., the target gNB) includes (or provide) the second set of configuration (e.g., the first configuration, the second configuration) in a response message (e.g., a second message, a handover request acknowledge, a message for providing handover configuration). Multiple second sets of configurations for multiple UEs may be included. One second set of configurations may correspond to one UE.

For example, the first network node (e.g., the source gNB) may transmit a message (e.g., a first message, a handover request message, a message for requesting handover configuration) to the second network node (e.g., the target gNB), wherein the message includes one UE ID and/or one UE context information (e.g., associated with the UE ID). The message with one UE ID (or UE context information) may be used to request a third set of configurations (e.g., the third configuration). Upon (or in response to, or if) receiving the message, the second network node (e.g., the target gNB) includes (or provide) the third set of configurations (e.g., the third configuration) in a response message (e.g., a second message, a handover request acknowledge, a message for providing handover configuration).

The handover configuration (e.g., the first configuration, the second configuration, the third configuration) may be (or include) one or more of the following:
spCellConfigCommon (or ServingCellConfigCommon);
The cell specific parameters for a serving cell (e.g., SpCell, PCell). The parameters may include: Physical Cell ID (PCI), common uplink configuration, common downlink configuration, ssb-PositionsInBurst, ssb-periodicityServingCell, ssbSubcarrierSpacing, and/or common Time Division Duplex (TDD)-UL-DL-configuration.
NTN configuration (or NTN-config);
The parameters needed for a UE to access NR via NTN access. The parameters may include: epoch time, validity duration, cell specific K_{offset}, K_{mac}, Timing Advance (TA) information, and/or ephemeris information.
One or more UE-specific configurations as above.

One or more of the above and herein embodiments, concepts, methods, and/or examples may be applied for the case that the target cell is an NTN cell. One or more of the above and herein embodiments, concepts, methods, examples may be applied for common handover, 2-step handover, and/or group handover.

The first configuration may be included in a common signaling and/or dedicated signaling for handover of an NTN cell. The first configuration may be included in a dedicated signaling for handover of a TN cell. The first configuration may not be included in a common signaling for handover of a TN cell.

The UE may determine whether to apply the first configuration in the common signaling (for a handover) based on whether the handover is for NTN or TN. The UE may determine whether to apply the first configuration in the common signaling (for a handover) based on whether the target cell is an NTN cell or TN cell. The UE may receive the first configuration in the common signaling (for a handover) based on the handover is for NTN and/or the target cell is an NTN cell. The UE may not receive the first configuration in the common signaling (for a handover) based on the handover is for TN and/or the target cell is a TN cell.

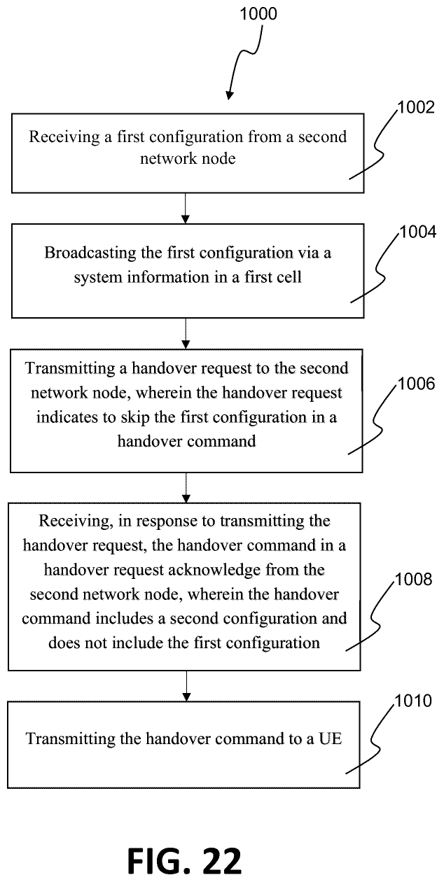

Referring to FIG. 22, with this and other concepts, systems, and methods of the present invention, a method 1000 for a first network node in a wireless communication system comprises receiving a first configuration from a second network node (step 1002), broadcasting the first configuration via a system information in a first cell (1004), transmitting a handover request to the second network node, wherein the handover request indicates to skip the first configuration in a handover command (step 1006), receiving, in response to transmitting the handover request, the handover command in a handover request acknowledge from the second network node, wherein the handover command includes a second configuration and does not include the first configuration (step 1008), and transmitting the handover command to a UE (step 1010).

In various embodiments, the method further comprises transmitting a request, to the second network node, to request the first configuration, wherein the request includes multiple or no UE context information, and receiving, in response to transmitting the request, the first configuration in a response.

In various embodiments, the request is another handover request and/or wherein the response is another handover request acknowledge.

In various embodiments, the first network node is a source gNB and/or wherein the second network node is a target gNB.

In various embodiments, the first configuration is a common configuration or servingCellConfigCommon for a target cell.

In various embodiments, the second configuration is a dedicated configuration of a UE for the target cell.

In various embodiments, the first configuration is a cell-specific configuration.

In various embodiments, the second configuration is a UE-specific configuration.

In various embodiments, the handover command is an RRC reconfiguration message.

In various embodiments, the handover request indicates to provide the second configuration.

In various embodiments, the handover request indicates to prepare a common handover.

In various embodiments, the RRC reconfiguration message is RRCReconfiguration with reconfigureWithSync.

In various embodiments, the first cell is a source cell.

Referring back to FIGS. 3 and 4, in one or more embodiments from the perspective of a first network node, the device 300 includes a program code 312 stored in memory 310 of the transmitter. The CPU 308 could execute program code 312 to: (i) receive a first configuration from a second network node; (ii) broadcast the first configuration via a system information in a first cell; (iii) transmit a handover request to the second network node, wherein the handover request indicates to skip the first configuration in a handover command; (iv) receive, in response to transmitting the handover request, the handover command in a handover request acknowledge from the second network node, wherein the handover command includes a second configuration and does not include the first configuration; and (v) transmit the handover command to a UE. Moreover, the CPU 308 can execute the program code 312 to perform all of the described actions, steps, and methods described above, below, or otherwise herein.

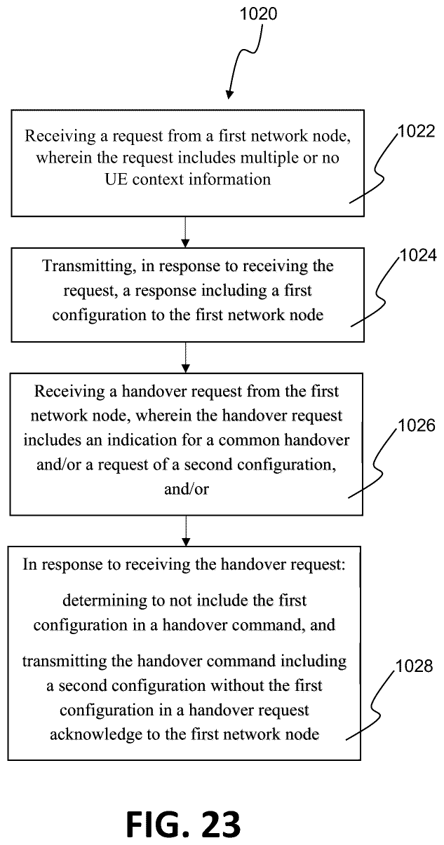

Referring to FIG. 23, with this and other concepts, systems, and methods of the present invention, a method 1020 for a second network node in a wireless communication system comprises receiving a request from a first network node, wherein the request includes multiple or no UE context information (step 1022), transmitting, in response to receiving the request, a response including a first configuration to the first network node (step 1024), receiving a handover request from the first network node, wherein the handover request includes an indication for a common handover and/or a request of a second configuration (step 1026), and/or in response to receiving the handover request: determining to not include the first configuration in a handover command, and transmitting the handover command including a second configuration without the first configuration in a handover request acknowledge to the first network node (step 1028).

Referring back to FIGS. 3 and 4, in one or more embodiments from the perspective of a second network node, the device 300 includes a program code 312 stored in memory 310 of the transmitter. The CPU 308 could execute program code 312 to: (i) receive a request from a first network node, wherein the request includes multiple or no UE context information; (ii) transmit, in response to receiving the request, a response including a first configuration to the first network node; (iii) receive a handover request from the first network node, wherein the handover request includes an indication for a common handover and/or a request of a second configuration; and/or (iv) in response to receiving the handover request: determine to not include the first configuration in a handover command, and transmit the handover command including a second configuration without the first configuration in a handover request acknowledge to the first network node. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium is known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a first network node, comprising:
receiving a first configuration from a second network node;
broadcasting the first configuration via a system information in a first cell;
transmitting a handover request to the second network node, wherein the handover request indicates to skip the first configuration in a handover command;
receiving, in response to transmitting the handover request, the handover command in a handover request acknowledge from the second network node, wherein the handover command includes a second configuration and does not include the first configuration; and
transmitting the handover command to a User Equipment (UE).

2. The method of claim 1, further comprising:
transmitting a request, to the second network node, to request the first configuration, wherein the request includes multiple or no UE context information; and
receiving, in response to transmitting the request, the first configuration in a response.

3. The method of claim 2, wherein the request is another handover request and/or wherein the response is another handover request acknowledge.

4. The method of claim 1, wherein the first network node is a source gNB and/or wherein the second network node is a target gNB.

5. The method of claim 1, wherein the first configuration is a common configuration or servingCellConfigCommon for a target cell.

6. The method of claim 1, wherein the second configuration is a UE-specific configuration.

7. The method of claim 1, wherein the handover command is a Radio Resource Control (RRC) reconfiguration message.

8. The method of claim 1, wherein the handover request indicates to provide the second configuration.

9. The method of claim 1, wherein the handover request indicates to prepare a common handover.

10. A method for a second network node, comprising:
receiving a request from a first network node, wherein the request includes multiple or no User Equipment (UE) context information;
transmitting, in response to receiving the request, a response including a first configuration to the first network node;
receiving a handover request from the first network node, wherein the handover request includes an indication for a common handover and/or a request of a second configuration; and/or
in response to receiving the handover request:
determining to not include the first configuration in a handover command; and
transmitting the handover command including a second configuration without the first configuration in a handover request acknowledge to the first network node.

11. A first network node, comprising:
a memory; and
a processor operatively coupled to the memory, wherein the processor is configured to execute a program code to:
receive a first configuration from a second network node;
broadcast the first configuration via a system information in a first cell;
transmit a handover request to the second network node, wherein the handover request indicates to skip the first configuration in a handover command;
receive, in response to transmitting the handover request, the handover command in a handover request acknowledge from the second network node, wherein the handover command includes a second configuration and does not include the first configuration; and
transmit the handover command to a User Equipment (UE).

12. The first network node of claim 11, further comprising:
transmitting a request, to the second network node, to request the first configuration, wherein the request includes multiple or no UE context information; and
receiving, in response to transmitting the request, the first configuration in a response.

13. The first network node of claim 12, wherein the request is another handover request and/or wherein the response is another handover request acknowledge.

14. The first network node of claim 11, wherein the first network node is a source gNB and/or wherein the second network node is a target gNB.

15. The first network node of claim 11, wherein the first configuration is a common configuration or servingCellConfigCommon for a target cell.

16. The first network node of claim 11, wherein the second configuration is a UE-specific configuration.

17. The first network node of claim 11, wherein the handover command is a Radio Resource Control (RRC) reconfiguration message.

18. The first network node of claim 17, wherein the RRC reconfiguration message is RRCReconfiguration with reconfigureWithSync.

19. The first network node of claim 11, wherein the handover request indicates to provide the second configuration.

20. The first network node of claim 11, wherein the handover request indicates to prepare a common handover.
